(19) United States
(12) Patent Application Publication
(10) Pub. No.: US 2015/0009138 A1
(43) Pub. Date: Jan. 8, 2015

(54) INFORMATION PROCESSING APPARATUS, OPERATION INPUT DETECTION METHOD, PROGRAM, AND STORAGE MEDIUM

(71) Applicant: Sony Corporation, Tokyo (JP)

(72) Inventors: TOMOYA NARITA, Kanagawa (JP); TAKEHIRO HAGIWARA, Kanagawa (JP); TAKU INOUE, Kanagawa (JP)

(21) Appl. No.: 14/314,417

(22) Filed: Jun. 25, 2014

(30) Foreign Application Priority Data
Jul. 4, 2013 (JP) 2013-140856

(51) Int. Cl. G06F 3/0354; H04N 5/30

(52) U.S. Cl. CPC G06F 3/03542; H04N 5/30
USPC 345/157

(57) ABSTRACT

There is provided an information processing apparatus including a recognition section which recognizes an irradiation position of laser light by a laser pointer on a projection image, an acquisition section which acquires information of a user operation detected by an operation section provided in the laser pointer, and a detection section which detects operation input information for the projection image based on the irradiation position recognized by the recognition section and the user operation acquired by the acquisition section.

### CROSS REFERENCE TO RELATED APPLICATIONS

This application claims the benefit of Japanese Priority Patent Application JP 2013-140856 filed Jul. 4, 2013, the entire contents of which are incorporated herein by reference.

### BACKGROUND

The present disclosure relates to an information processing apparatus, an operation input detection method, a program, and a storage medium.

Projectors which can display images projected on a large-sized screen are used in various situations, such as for meetings or presentations in companies or for classes in schools. Further, it is well known that laser pointers which project laser light on a projection image are used when describing an image magnified and projected by a projector. In recent years, technologies for using laser pointers, which have such a function for projecting laser light, in UI operations of a projector have been proposed such as follows.

For example, JP 2001-125738A discloses a control system which recognizes movements of a laser pointer, by calculating a difference of captured image data capturing a projection image surface with projection image data, and executes commands associated with prescribed movements of the laser pointer. Specifically, in the case where a pointer irradiated by a laser pointer moves so as to form a right arrow, such a control system will perform a control so as to execute an associated display command such as “proceed to the next slide”.

Further, JP 2008-15560A presents a determination system for correctly detecting an indicated position of a laser pointer on a projection image by a projector, even in the case where the brightness of a screen installation location changes. Specifically, such a determination system sets a pointer position determination threshold value prior to starting projection, calculates image data of a difference between captured image data of the present frame and captured image data of the previous frame, and determines an image position exceeding the threshold value as an irradiation position by the laser pointer.

### SUMMARY

However, in JP 2001-125738A and JP 2008-15560A, only coordinates of an irradiation position of laser light by the laser pointer are recognized based on a captured image.

Accordingly, the present disclosure proposes a new and improved information processing apparatus, operation input detection method, program and storage medium capable of intuitively performing an operation input for a projection image by using a laser pointer.

According to an embodiment of the present disclosure, there is provided an information processing apparatus including a recognition section which recognizes an irradiation position of laser light by a laser pointer on a projection image, an acquisition section which acquires information of a user operation detected by an operation section provided in the laser pointer, and a detection section which detects operation input information for the projection image based on the irradiation position recognized by the recognition section and the user operation acquired by the acquisition section.

According to another embodiment of the present disclosure, there is provided an operation input detection method including recognizing an irradiation position of laser light by a laser pointer on a projection image, acquiring information of a user operation detected by an operation section provided in the laser pointer, and detecting operation input information for the projection image based on the recognized irradiation position and the acquired user operation.

According to still another embodiment of the present disclosure, there is provided a program for causing a computer to function as a recognition section which recognizes an irradiation position of laser light by a laser pointer on a projection image, an acquisition section which acquires information of a user operation detected by an operation section provided in the laser pointer, and a detection section which detects operation input information for the projection image based on the irradiation position recognized by the recognition section and the user operation acquired by the acquisition section.

There is yet another embodiment of the present disclosure, there is provided a non-transitory computer-readable storage medium having a program stored therein, the program causing a computer to function as a recognition section which recognizes an irradiation position of laser light by a laser pointer on a projection image, an acquisition section which acquires information of a user operation detected by an operation section provided in the laser pointer, and a detection section which detects operation input information for the projection image based on the irradiation position recognized by the recognition section and the user operation acquired by the acquisition section.

According to one or more of embodiments of the present disclose such as described above, it becomes possible to intuitively perform an operation input for a projection image by using a laser pointer.

### BRIEF DESCRIPTION OF THE DRAWINGS

FIG. 1 is a figure for describing an outline of an operation system according to an embodiment of the present disclosure;

FIG. 2 is a figure for describing an overall configuration of the operation system according to a first embodiment of the present disclosure;

FIG. 3A is a figure for describing a first irradiation method of laser light and a non-visible light marker corresponding to a user operation by a laser pointer according to the first embodiment;

FIG. 3B is a figure for describing a second irradiation method of laser light and a non-visible light marker corresponding to a user operation by a laser pointer according to the first embodiment;

FIG. 4A is a figure for describing a plurality of operation buttons included in the laser pointer according to the first embodiment;

FIG. 4B is a figure for describing a touch panel included in the laser pointer according to the first embodiment;

FIG. 5 is a block diagram which shows an example of an internal configuration of the operation system according to the first embodiment;

FIG. 6 is a sequence diagram which shows operation processes according to the first embodiment;

FIG. 7 is a flow chart which shows operation processes of a projector according to the first embodiment;

FIG. 8 is a figure for describing the laser pointer according to a modified example of the first embodiment;

FIG. 9 is a block diagram which shows an example of an internal configuration of the operation system according to the modified example of the first embodiment;

FIG. 10 is a figure for describing an overall configuration of the operation system according to a second embodiment of the present disclosure;

FIG. 11 is a block diagram which shows an example of an internal configuration of the operation system according to the second embodiment;

FIG. 12 is a figure for describing an overall configuration of the operation system according to a third embodiment of the present disclosure;

FIG. 13 is a block diagram which shows an example of an internal configuration of the operation system according to the third embodiment;

FIG. 14 is a figure for describing an overall configuration of the operation system according to a fourth embodiment of the present disclosure;

FIG. 15 is a block diagram which shows an example of an internal configuration of a communication terminal according to the fourth embodiment;

FIG. 16 is a figure for describing an overall configuration of the operation system according to a fifth embodiment of the present disclosure;

FIG. 17 is a block diagram which shows an example of an internal configuration of the operation system according to the fifth embodiment;

FIG. 18 is a figure for describing an overall configuration of the operation system according to a sixth embodiment of the present disclosure;

FIG. 19 is a block diagram which shows an example of an internal configuration of the operation system according to the sixth embodiment;

FIG. 20 is a figure for describing an overall configuration of the operation system according to a seventh embodiment of the present disclosure; and

FIG. 21 is a block diagram which shows an example of an internal configuration of the communication terminal according to the seventh embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

The description will be given in the following order.

1. Outline of the operation system according to an embodiment of the present disclosure

2. Each of the embodiments

2-1. The first embodiment

2-1-1. Overall configuration

2-1-2. Internal configuration

2-1-3. Operation processes

2-1-4. Modified example

2-2. The second embodiment

2-3. The third embodiment

2-4. The fourth embodiment

2-5. The fifth embodiment

2-6. The sixth embodiment

2-7. The seventh embodiment

3. Conclusion

### 1. OUTLINE OF THE OPERATION SYSTEM ACCORDING TO AN EMBODIMENT OF THE PRESENT DISCLOSURE

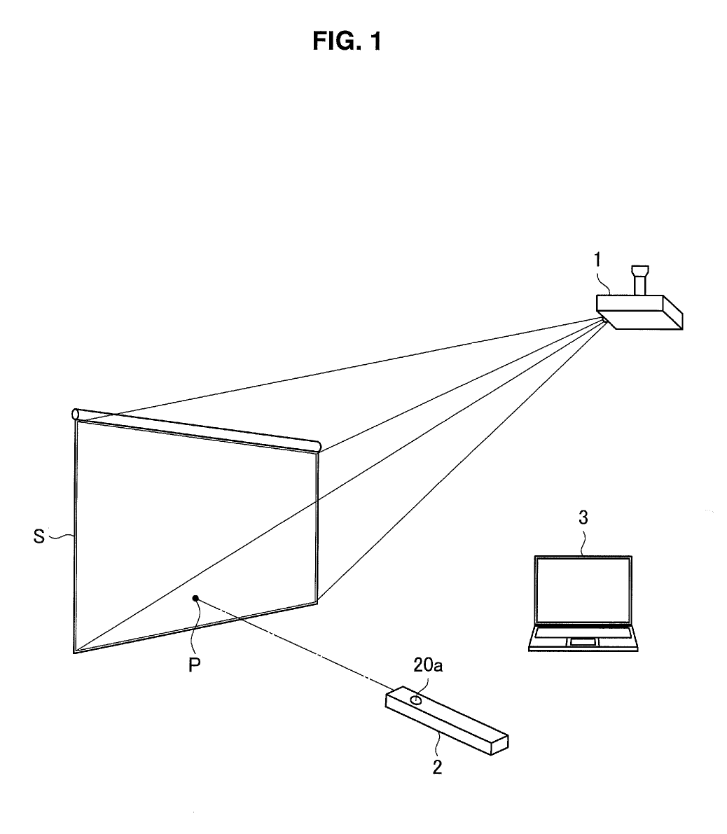

First, an outline of an operation system according to an embodiment of the present disclosure will be described with reference to FIG. 1. As shown in FIG. 1, the operation system according to an embodiment of the present disclosure includes a projector 1, a laser pointer 2, and a PC (Personal Computer) 3 which outputs projection content to the projector 1. The projection content are images, text, other various graphic images, maps, websites or the like, and hereinafter will be called projection image data.

The projector 1 projects image data received from the PC 3 on a projection screen or wall (hereinafter, a screen S will be used as an example) in accordance with a control signal from the PC 3.

The laser pointer 2 has a function which irradiates laser light (visible light), in accordance with a pressing operation of an operation button 20a by a user (speaker). The user can make a presentation while indicating an irradiation position P matching a description location, by using the laser pointer 2 and irradiating laser light on an image projected on the screen S.

The PC 3 electrically generates an image for projection, transmits image data to the projector 1 by wires/wirelessly, and performs projection control. While a notebook-type PC is shown in FIG. 1 as an example, the PC 3 according to the present embodiment is not limited to a notebook-type PC, and may be a desktop-type PC or a server on a network (cloud).

(Background)

Here, as described above, in JP 2001-125738A and JP 2008-15560A, only coordinates of an irradiation position of laser light by the laser pointer are recognized based on a captured image capturing a projection image. Therefore, for example, in order to input a command such as “proceed to the next slide”, it may be necessary for complex gestures such as drawing a figure of a right arrow on the projection image by laser light.

Further, a method is known which transmits control signals to a projector or PC by using a separate remote controller, and in this case, a user (speaker) operates the remote controller by turning his or her eyes from the projection image or the audience, and it may be necessary for the user direct his or her attention to the projector or the PC.

There is no operation method referring to a method which performs an intuitive operation input for a projection image by a laser pointer, such as an operation, for example, which moves a mouse cursor on a display screen by a mouse and clicks a button on the screen.

Accordingly, focusing on the above described situation has led to creating the operation system according to each of the embodiments of the present disclosure. The operation system according to each of the embodiments of the present disclosure can perform an intuitive operation input for a projection image by using a laser pointer. Hereinafter, the operation system according to each of the embodiments of the present disclosure will be specifically described.

### 2. EACH OF THE EMBODIMENTS

### 2-1. The First Embodiment

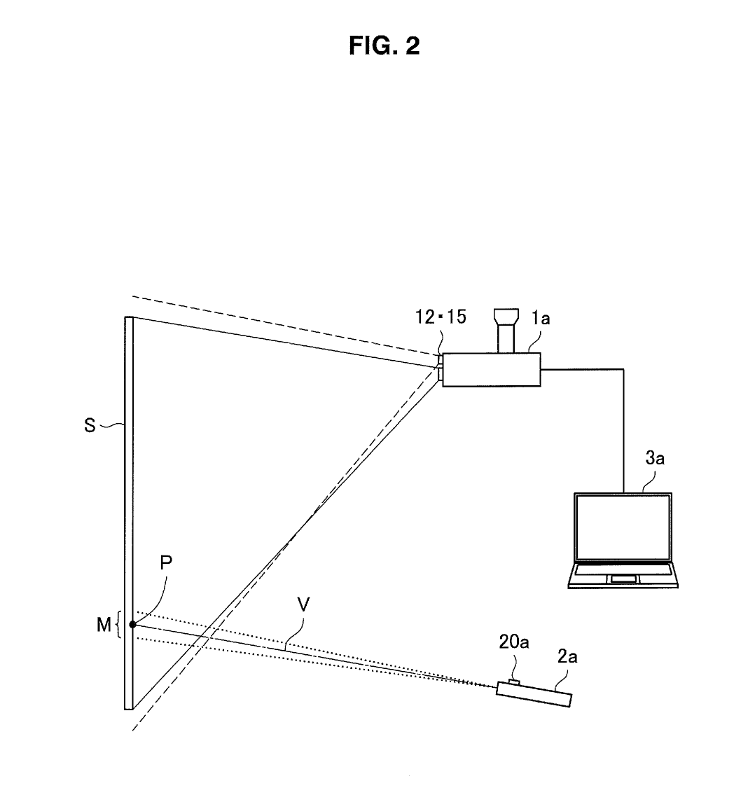

First, an overall configuration of the operation system according to a first embodiment will be described with reference to FIG. 2.

### 2-1-1. Overall Configuration

FIG. 2 is a figure for describing an overall configuration of the operation system according to the first embodiment. As shown in FIG. 2, the operation system according to the present embodiment includes a projector 1a (an information processing apparatus according to an embodiment of the present disclosure), a laser pointer 2a, and a PC 3a.

The projector 1a according to the present embodiment connects to the PC 3a by wires/wirelessly, and projects an image received from the PC 3a on a screen S. Further, the projector 1a has imaging sections (a non-visible light imaging section 12 and a visible light imaging section 15) for recognizing irradiation by the laser pointer 2a on a projection image. The imaging sections may be built into the projector 1a, or may be externally attached.

Further, by including the projector 1a, the imaging sections can automatically perform calibration of a range of the projection image to be captured. Specifically, the imaging sections can change an imaging range or imaging direction in conjunction with the projection direction by the projector 1a. Note that, by having the imaging sections capture areas of a range wider than the range of the projection image, laser irradiation can be used in UI operations for a range outside that of the projection image (outside of the image).

The laser pointer 2a irradiates laser light V of visible light rays which can be seen by a person's eyes, and a non-visible light marker M, in accordance with the pressing of an operation button 20a included in the laser pointer 2a. The laser pointer 2a is used in order for a user to indicate an arbitrary position on a projection image by the laser light V. Further, the non-visible light marker M is irradiated to a position the same or near the irradiation position P of the laser light V, and is irradiated by light rays which are not able to be seen by a person's eyes such as infrared light, for example. Irradiation of the non-visible light marker M is controlled in accordance with a user operation (operation input) for a detected projection image in the laser pointer 2a.

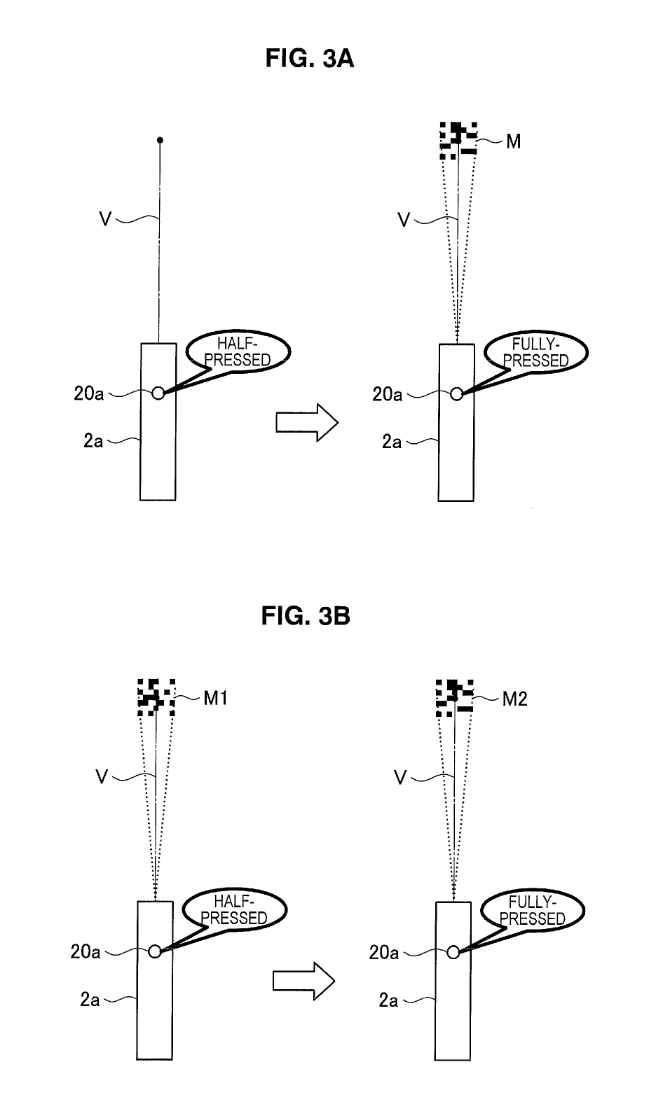

Specifically, as shown in FIG. 3A, the laser pointer 2a irradiates only the laser light V in the case where the operation button 20a is half-pressed, and irradiates the laser light V and the non-visible light marker M in the case where the operation button 20a is fully-pressed (completely pressed). Information (a user ID or the like) may be embedded in the non-visible light marker M, such as in the two-dimensional bar code shown in FIG. 3 or in a one-dimensional bar code, or the non-visible light marker M may be only a point with the same shape as that of the laser light or may be an arbitrary shape (a cross type, a heart type or the like). Further, the non-visible light marker M is not limited to a still image, and may be a moving image which blinks by changing color or shape. By having the image change, it becomes easier to recognize the image in the position recognition section.

Further, as shown in FIG. 3B, the laser pointer 2a may irradiate the laser light V and a non-visible light marker M1 in the case where the operation button 20a is half-pressed (a first stage operation), and may irradiate the laser light V and a non-visible light marker M2 in the case where the operation button 20a is fully-pressed (a second stage operation). For example, a user ID is embedded in the non-visible light marker M1 irradiated in the half-pressed state, and a user ID and user operation information (the button being fully-pressed) is embedded in the non-visible light marker M2 irradiated in the fully-pressed state.

In this way, the laser pointer 2a according to the present embodiment controls the irradiation of the non-visible light marker M in accordance with a user operation detected by the operation button 20a. The user operation detected by the operation button 20a is not limited to “half-pressed” and “fully-pressed” shown in FIG. 3A and FIG. 3B, and may be the number of times a button is pressed (pressed two times in a row or the like).

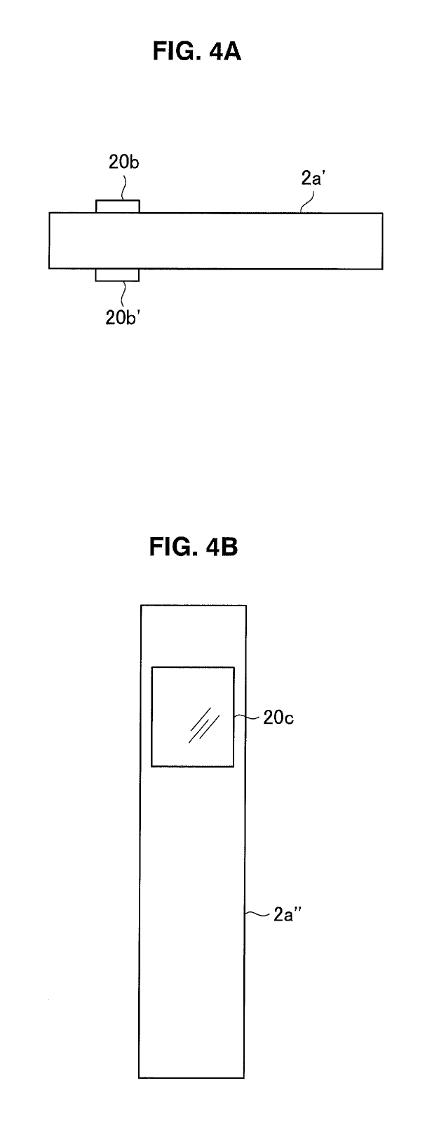

Further, the operation section included in the laser pointer 2a is not limited to a configuration in which user operations of a plurality of stages can be detected by one operation button 20a, and may be a configuration which detects user operations of a plurality of stages by a plurality of operation buttons 20b and 20b′, such as shown in FIG. 4A. As shown in FIG. 4A, operation buttons 20b and 20b′ are included in the upper surface and lower surface, respectively, of the housing of the laser pointer 2a′ according to the present embodiment. Also, the laser pointer 2a′ irradiates only the laser light V in the case where the operation button 20b is pressed, and irradiates the laser light V and the non-visible light marker M in the case where the operation button 20b′ is also pressed. In this way, the laser pointer 2a′ detects user operations of the two stages of a stage where the button is pressed once (a first stage) and a stage in which the button is pressed twice (a second stage), and controls the irradiation of the non-visible light marker M in accordance with the detected user operation.

Further, two left and right operation buttons are included side by side on the upper surface of the laser pointer 2a, and it may be possible to perform user operations similar to the operations of a mouse such as a left click and a right click. The laser pointer 2a performs a control so as to irradiate a different non-visible light marker M in accordance with a left click or a right click. Further, in this case, an ON/OFF switch of the laser light may be included separately in the laser pointer 2a.

In addition, the operation section included in the laser pointer 2a is not limited to that implemented by a physical structure such as the above described operation buttons 20a, 20b and 20b′, and may be implemented by a sensor which detects contact/proximity of a finger. For example, as shown in FIG. 4B, a user operation is detected by a touch panel 20c included in a laser pointer 2a″. The laser pointer 2a″ performs a control so as to irradiate a different non-visible light marker M in accordance with contact/proximity of a finger, the frequency of contact (tap frequency) or the like by the touch panel 20c. Further, in this case, the laser pointer 2a″ may irradiate the laser light V in the case where a finger is continuously contacting/proximate to the touch panel 20c, and an ON/OFF switch of laser light V irradiation may be included separately in the laser pointer 2a″.

Note that, the shape of the laser pointer 2a is not limited to the shape shown in FIG. 2 to FIG. 4B, and may be the shape, for example, of a pointer in which the irradiation section is included in the tip. Further, the number of buttons included in the laser pointer 2a is not limited to the examples shown in FIG. 3A or FIG. 4A, and may be three or more, for example. By including a plurality of buttons, it is possible for a user to arbitrarily select a color of a visible light laser (for example, a button for red laser emission, a button for blue laser emission, a button for green laser emission or the like).

As described above, the laser pointer 2a according to the present embodiment irradiates laser light V (visible light) for indicating an arbitrary location on a projection image, and a non-visible light marker M corresponding to a user operation such as a button press or tap operation detected by the laser pointer 2a.

The laser light V (visible light) and the non-visible light marker M irradiated by the laser pointer 2a are captured by imaging sections (a non-visible light imaging section 12 and a visible light imaging section 15) included in the projector 1a, and irradiation position coordinates, user operation information or the like are recognized in the projector 1a. The projector 1a combines an irradiation position P of the recognized laser light V and the user operation information based on the non-visible light marker M, and transmits the combination to the PC 3a as operation input information.

The PC 3a executes a control in accordance with the operation input information received from the projector 1a, and transmits projection image data, in which the operation input information is reflected, to the projector 1a.

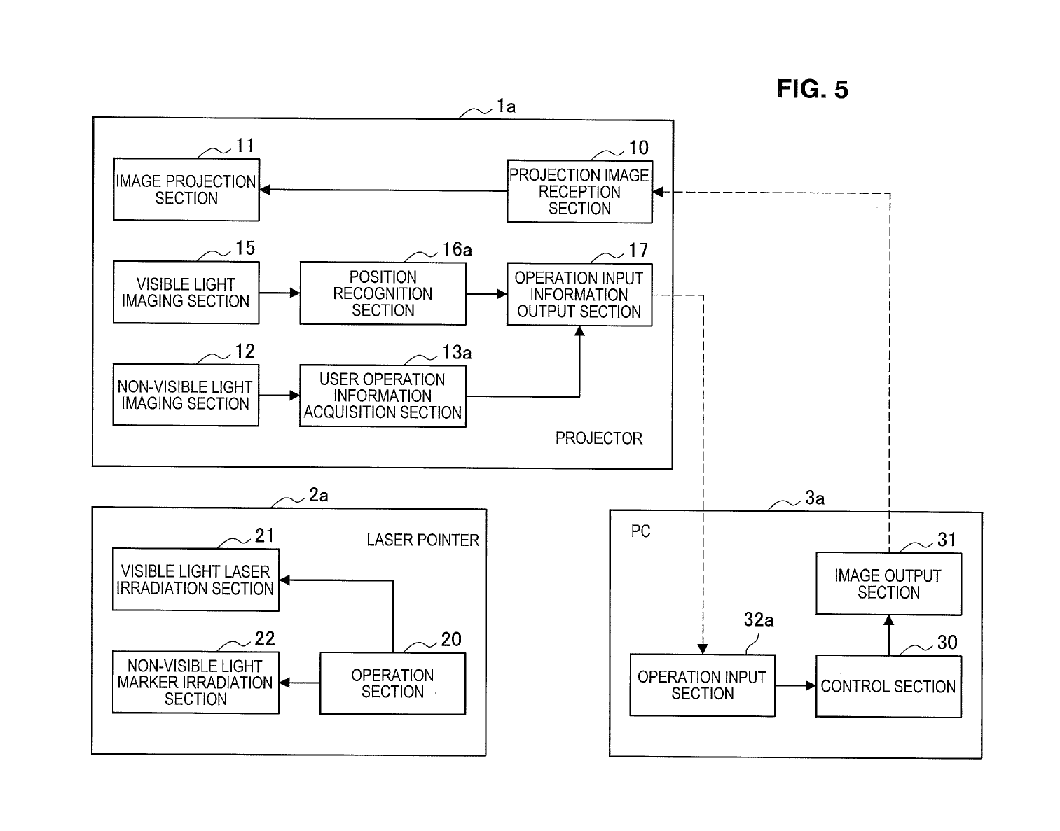

In this way, according to the operation system according to the present embodiment, an intuitive operation input (corresponding to a mouse click) can be performed, such as pressing the operation button 20a, in accordance with an irradiation position P (corresponding to a mouse cursor) of the laser light V irradiated from the laser pointer 2a to an arbitrary position on a projection image. To continue, an internal configuration of each apparatus included in the operation system according to the present embodiment will be specifically described with reference to FIG. 5.

### 2-1-2. Internal Configuration

FIG. 5 is a block diagram which shows an example of an internal configuration of the operation system according to the first embodiment.

(Projector 1a)

As shown in FIG. 5, the projector 1a has a projection image reception section 10, an image projection section 11, a non-visible light imaging section 12, a user operation information acquisition section 13a, a visible light imaging section 15, a position recognition section 16a, and an operation input information output section 17.

The projection image reception section 10 receives projection image data from the PC 3a by wires/wirelessly, and outputs the received image data to the image projection section 11.

The image projection section 11 reflects (projects) the image data sent from the image projection section 11 on a projection screen or wall.

The non-visible light (invisible light) imaging section 12 has a function which captures a non-visible light marker M irradiated by the laser pointer 2a on a projected image. For example, the non-visible light imaging section 12 is implemented by an infrared camera or an ultraviolet camera. The non-visible light imaging section 12 outputs the captured non-visible light image to the user operation information acquisition section 13a.

The user operation information acquisition section 13a functions as an acquisition section which acquires information of a user operation detected by the operation section 20 included in the laser pointer 2a, based on a non-visible light captured image capturing the non-visible light marker M. For example, the user operation information acquisition section 13a recognizes the presence of the non-visible light marker M, the shape of the non-visible light marker M, and information or the like embedded in the non-visible light marker M, by analyzing a non-visible light captured image, and acquires associated user operation information. For example, associated user operation information is fully pressing, pressing two times in a row, a right click, a left click or the like of the operation button 20a.

The user operation information acquisition section 13a outputs the acquired user operation information to the operation input information output section 17.

The visible light imaging section 15 has a function which captures a pointer (irradiation position P) of the laser light V irradiated by the laser pointer 2a on an image projected by the image projection section 11. The visible light imaging section 15 outputs the captured visible light image to the position recognition section 16a.

The position recognition section 16a functions as a recognition section which recognizes the irradiation position P of the laser light V by the laser pointer 2a on the projection image, based on a visible light captured image capturing the projection image. For example, the position recognition section 16a detects the irradiation position P (for example, position coordinates), by detecting a difference of the visible light captured image capturing the projection image with the image projected by the image projection section 11. Further, the position recognition section 16a can improve the accuracy by adding, to the analysis, a difference between the visible light captured image of the frame prior to the image currently projected and the visible light captured image of the image currently projected. Note that, the above described “frame prior to the image currently projected” is not limited to one frame prior, and may be a number of frames prior such a two frames, three frames or the like. It is possible to further improve the accuracy compared with a plurality of frames.

The position recognition section 16a outputs information which shows the recognized irradiation position P (for example, position coordinates) to the operation input information output section 17.

The operation input information output section 17 functions as a detection section which detects operation input information for the projection image, based on user operation information output from the user operation information acquisition section 13a and information which shows the irradiation position P output from the position recognition section 16a. Specifically, the operation input information output section 17 detects prescribed user operation information being input as operation input information for the position coordinates shown by the irradiation position P on the projection image. Further, the operation input information output section 17 also functions as a transmission section which transmits the detected operation input information to the PC 3a by wires/wirelessly.

Heretofore, an internal configuration of the projector 1a has been specifically described. Note that, in order to improve the accuracy of the recognition of the irradiation position P by the position recognition section 16a, and the recognition of the non-visible light marker M by the user operation information acquisition section 13a, the image projection section 11 of the projector 1a may narrow the projection color region.

Specifically, for example, in order to improve the accuracy of the recognition of the non-visible light marker M, the image projection section 11 cuts non-visible light from the projection light. Further, in order to improve the accuracy of the recognition of the irradiation position P, the image projection section 11 may appropriately darken the projection image. The timing at which the projection image is darkened may be triggered in the case where the laser light V is irradiated from the position recognition section 16a (for example, in the case where the irradiation position P is recognized). Further, by scan irradiating the projection image by the image projection section 11, it is possible for the irradiation position P to be easily recognized.

(Laser Pointer 2a)

As shown in FIG. 5, the laser pointer 2a has an operation section 20, a visible light laser irradiation section 21, and a non-visible light marker irradiation section 22.

The operation section 20 has a function which detects a user operation, and is implemented, for example, by the operation button 20a shown in FIG. 3A, the operation buttons 20b and 20b′ shown in FIG. 4A, the touch panel 20c shown in FIG. 4B, or a laser light ON/OFF switch (not shown in the figures). The operation section 20 outputs the detected user operation to the visible light laser irradiation section 21 or the non-visible light marker irradiation section 22.

The visible light laser irradiation section 21 has a function which irradiates a visible light laser (called laser light) in accordance with a user operation. For example, the visible light laser irradiation section 21 irradiates a visible light laser in the case where the operation button 20a is half-pressed, in the case where the operation button 20b is fully-pressed, or in the case where the laser light ON/OFF switch is turned “ON”.

The non-visible light marker irradiation section 22 has a function which irradiates a non-visible light marker (called a non-visible light image) in accordance with a user operation. For example, the non-visible light marker irradiation section 22 irradiates a non-visible light marker, in the case where the operation button 20a is fully-pressed, in the case where the operation buttons 20b and 20b′ are simultaneously pressed, or in the case where the touch panel 20c is tapped. The non-visible light marker may be only a point with the same shape as that of the laser light or may be an arbitrary shape (a cross type, a heart type or the like).

Further, in the case where a visible light laser is irradiated by the visible light laser irradiation section 21, the non-visible light marker irradiation section 22 may irradiate a non-visible light marker at the same position or near the irradiation position P of the laser light. In this case, the non-visible light marker irradiation section 22 may irradiate information (a user ID or the like) which is embedded, such as in a two-dimensional bar code or in a one-dimensional bar code, as a non-visible light marker. Also, in the case where a user operation of a plurality of stages is detected, such as the operation button 20a being fully-pressed, the non-visible light marker irradiation section 22 changes the non-visible light marker to be irradiated in accordance with the user operation.

(PC 3a)

As shown in FIG. 5, the PC 3a has a control section 30, an image output section 31, and an operation input section 32a.

The control section 30 has a function which controls all the elements of the PC 3a. Specifically, for example, the control section 30 can reflect the operation input information detected by the operation input section 32a in the projection image data which is output (transmitted) to the projector 1a by the image output section 31.

The operation input section 32a has a function which accepts an input of a user operation (operation input information) from a keyboard, mouse or the like of the PC 3a. Further, the operation input section 32a functions as a reception section which receives operation input information from the projector 1a. The operation input section 32a outputs the accepted operation input information to the control section 30.

The image output section 31 has a function which transmits projection image data to the projector 1a by wires/wirelessly. The transmission of projection image data may be continuously performed. Further, operation input information received by the operation input section 32a is reflected, by the control section 30, in the projection image data transmitted to the projector 1a.

By the above described configuration, first, a user operation (a fully-pressed operation of the operation button 20a, a touch operation of the touch panel 20c or the like), which is performed by a user for a projection image by using the laser pointer 2a, is recognized in the projector 1a via the non-visible light marker. To continue, the projector 1a transmits operation input information, which includes an irradiation position P by the visible light laser and a user operation recognized based on the non-visible light marker, to the PC 3a. The PC 3a performs a process in accordance with the operation input information, and transmits an image for projection reflecting this process to the projector 1a. Also, the projector 1a projects an image for projection in which the process in accordance with the operation input information is reflected.

In this way, the user can perform an intuitive operation input for a projection image by using the laser pointer 2a, without it being necessary for the laser pointer 2a to communicate with the PC 3a. Note that, the configuration of the projector 1a according to the present embodiment is not limited to the example shown in FIG. 5. For example, the projector 1a may not have the visible light imaging section 15. In this case, the position recognition section 16a recognizes the coordinate position of the non-visible light marker captured by the non-visible light imaging section 12 as the irradiation position P.

Or, the projector 1a may not have the non-visible light imaging section 12. In this case, the visible light laser irradiation section 21 of the laser pointer 2a irradiates a visible light marker which changes in accordance with a user operation. Information (a user ID or the like) may be embedded in the visible light marker, such as in a two-dimensional bar code or in a one-dimensional bar code, or the visible light marker may be only a point with the same shape as that of the laser light or may be an arbitrary shape (a cross type, a heart type or the like). Further, the visible light marker is not limited to a still image, and may be a moving image which blinks by changing color or shape. By having the image change, it becomes easier to recognize the image in the position recognition section. Also, the user operation information acquisition section 13a of the projector 1a acquires user operation information, by analyzing the presence, color, shape or the like of the visible light marker captured by the visible light imaging section 15. In this way, by having a visible light marker which can be seen by a person's eyes irradiated in accordance with a user operation, feedback of an operation input can be implemented for a user.

### 2-1-3. Operation Processes

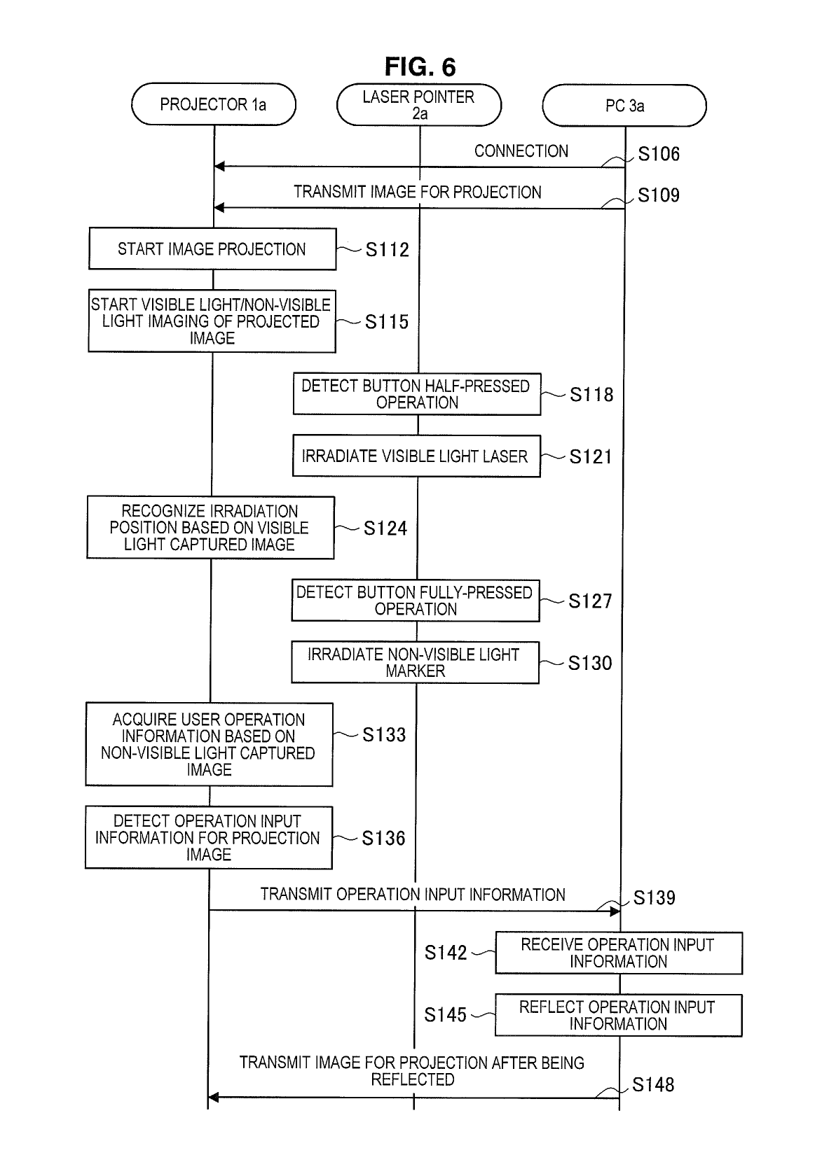

Next, operation processes of such an operation system according to the present embodiment will be described with reference to FIG. 6. FIG. 6 is a sequence diagram which shows operation processes according to the first embodiment. As shown in FIG. 6, first in step S106, the PC 3a and the projector 1a are connected by wires/wirelessly. The connection method is not particularly limited in the present disclosure.

Next, in step S109, the image output section 31 of the PC 3a transmits projection image data to the projector 1a.

Next, in step S112, the image projection section 11 of the projector 1a projects a projection image received from the projector 1a by the projection image reception section 10 on a screen S.

Next, in step S115, the projector 1a starts visible light imaging for a range of the projection image by the visible light imaging section 15, and non-visible light imaging for a range of the projection image by the non-visible light imaging section 12.

On the other hand, in steps S118 and S121, the laser pointer 2a irradiates a visible light laser in accordance with a user operation. Specifically, for example, in the case where the operation button 20a is half-pressed, the laser pointer 2a irradiates laser light by the visible light laser irradiation section 21. In this way, a user (speaker) can carry out an explanation to an audience while indicating an arbitrary location within the projection image by the laser light.

Next, in step S124, the position recognition section 16a of the projector 1a recognizes an irradiation position P (coordinate position) of the laser light, based on a visible light captured image captured by the visible light imaging section 15.

Next, in steps S127 and S130, the laser pointer 2a irradiates a non-visible light marker in accordance with a user operation. Specifically, for example, in the case where the operation button 20a is fully-pressed, the laser pointer 2a irradiates a non-visible light marker by the non-visible light marker irradiation section 22 at the same position or near the laser light. In this way, a user (speaker) can intuitively perform a click operation for an indicated location, while indicating an arbitrary location within the projection image by the laser light.

To continue, in step S133, the user operation information acquisition section 13a of the projector 1a analyzes the presence, shape or the like of the non-visible light marker, based on the non-visible light captured image captured by the non-visible light imaging section 12, and acquires user operation information. For example, in the case where the non-visible light marker is irradiated on the projection image, or in the case where the non-visible light marker is a prescribed shape, the user operation information acquisition section 13a acquires a “fully-pressed operation” as the user operation information. Further, the user operation information acquisition section 13a can acquire a “fully-pressed operation” as the user operation information, from information embedded in the non-visible light marker irradiated on the projection image.

Next, in step S136, the operation input information output section 17 of the projector 1a detects operation input information for the projection image, based on the irradiation position P recognized by the position recognition section 16a, and the user operation information acquired by the user operation information acquisition section 13a.

Next, in step S139, the operation input information output section 17 of the projector 1a transmits the detected operation input information to the PC 3a.

To continue, in step S142, the operation input section 32a of the PC 3a receives the operation input information from the projector 1a.

Next, in step S145, the control section 30 of the PC 3a reflects the received operation input information in the projection image data. Specifically, for example, in the case where the operation input information is information which shows a “(fully-pressed operation) for an irradiation position P (coordinate position)”, the control section 30 executes a process, in which a click operation is input for a position corresponding to the irradiation position P, of the currently projected image.

Then, in step S148, the image output section 31 of the PC 3a transmits an image for projection after being reflected (after the process in accordance with the operation input information) to the projector 1a.

After this, the above described steps S112 to S148 are repeated. In this way, a user (speaker) can intuitively perform an operation input for an indicated location by using the laser pointer 2a, while indicating an arbitrary location within the projection image by the laser light. For example, a user (speaker) can intuitively perform an operation similar to an operation using a mouse, such as a click operation, a drag operation or a double click operation, for a projection image.

Note that, as described above, the position recognition section 16a of the projector 1a according to the present embodiment may recognize a coordinate position of the non-visible light marker as the position (irradiation position P) indicated by the laser pointer 2a. In this case, in the above described step S115, the projector 1a starts only non-visible light imaging for a range of the projection image by the non-visible light imaging section 12. Then, in the above described step S124, the position recognition section 16a recognizes the irradiation position P based on a visible light captured image captured by the non-visible light imaging section 12.

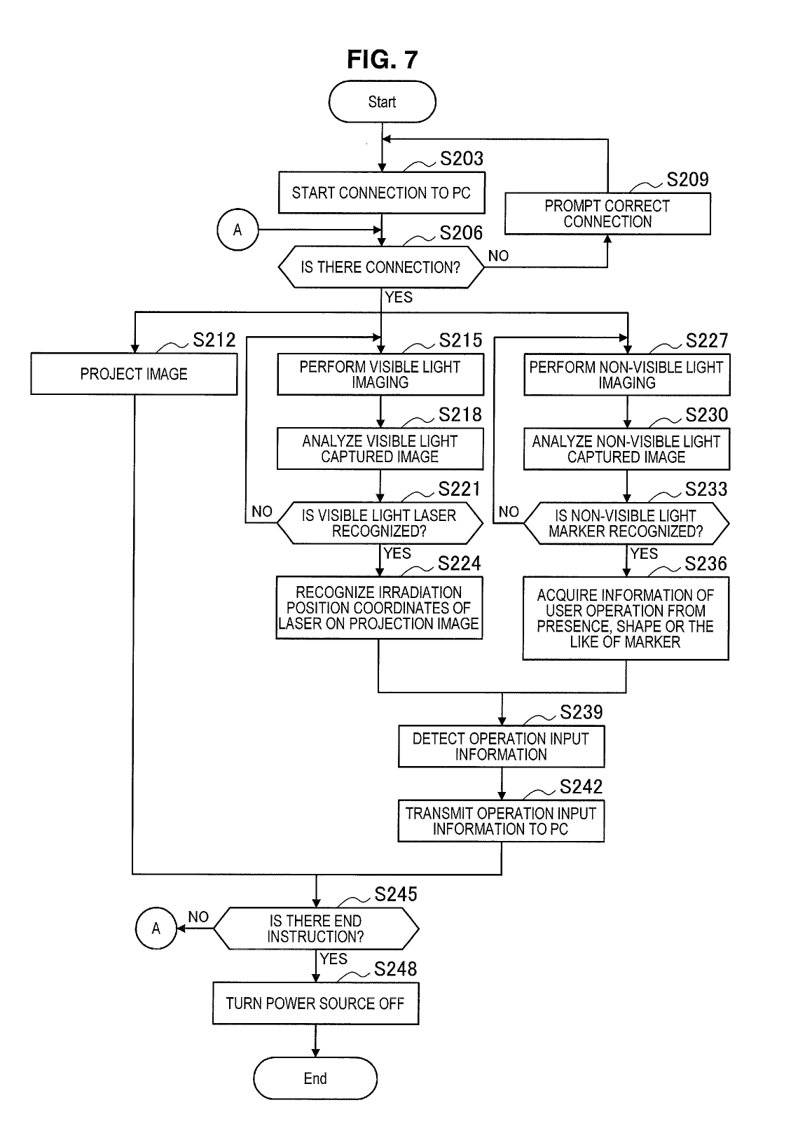

The operation processes described above with reference to FIG. 6 are all processes by the projector 1a, the laser pointer 2a and the PC 3a included in the operation system according to the present embodiment. Here, operation processes specific to the projector 1a (an information processing apparatus according to an embodiment of the present disclosure) according to the present embodiment will be specifically described with reference to FIG. 7.

FIG. 7 is a flow chart which shows operation processes of the projector 1a according to the first embodiment. As shown in FIG. 7, first in step S203, the projector 1a connects to the PC 3a by wires/wirelessly.

Next, in step S206, the projector 1a judges whether or not it is correctly connected, and in the case where it is not correctly connected (S206/No), in step S209, a correct connection is prompted to the PC 3a.

On the other hand, in the case where it is correctly connected (S206/Yes), the projector 1a performs image projection by the image projection section 11 (S212), visible light imaging by the visible light imaging section 15 (S215), and non-visible light imaging by the non-visible light imaging section 12 (S227).

Specifically, in step S212, the projector 1a projects, by the image projection section 11, an image received from the PC 3a by the projection image reception section 10 on the screen S.

Further, in step S215, the projector 1a performs visible light imaging, by the visible light imaging section 15, for the projection image projected on the screen S.

Next, in step S218, the position recognition section 16a of the projector 1a analyzes a visible light captured image.

Next, in step S221, the position recognition section 16a judges whether or not a point by a visible light laser can be recognized from the visible light captured image.

Next, in the case where a point by a visible light laser can be recognized (S221/Yes), in step S224, the position recognition section 16a recognizes position coordinates (irradiation position P) of the point by the visible light laser.

On the other hand, in step S227, the projector 1a performs non-visible light imaging for the projection image projected on the screen S, by the non-visible light imaging section 12.

Next, in step S230, the user operation information acquisition section 13a of the projector 1a analyzes a non-visible light captured image.

Next, in step S233, the user operation information acquisition section 13a judges whether or not a non-visible light marker can be recognized from the non-visible light captured image.

Next, in the case where a non-visible light marker can be recognized (S233/Yes), in step S236, the user operation information acquisition section 13a acquires information of a user operation, from the presence, shape or the like of the non-visible light marker.

To continue, in step S239, the operation input information output section 17 detects operation input information for the projection image, based on the irradiation position P recognized by the position recognition section 16a, and user operation information acquired by the user operation information acquisition section 13a.

Next, in step S242, the operation input information output section 17 transmits the detected operation input information to the PC 3a. The operation input information transmitted to the PC 3a is reflected in an image for projection in the PC 3a, the reflected image for projection is transmitted from the PC 3a, and the reflected image for projection is projected by the image projection section 11 in the above described step S212.

Then, in step S245, the processes shown in the above described steps S206 to S242 are repeated up until there is an end instruction (instruction of power source OFF).

Finally, in the case where there is an end instruction (S245/Yes), in step S248, the projector 1a turns the power source of the projector 1a OFF.

### 2-1-4. Modified Example

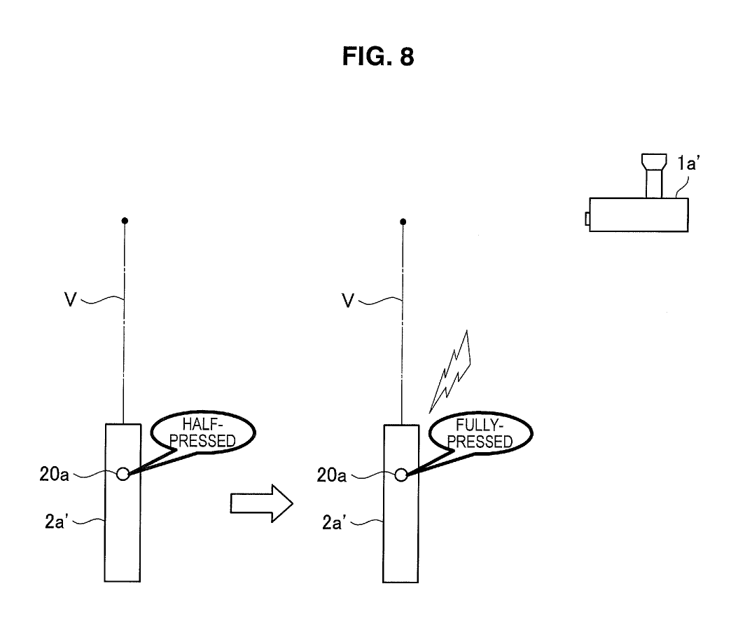

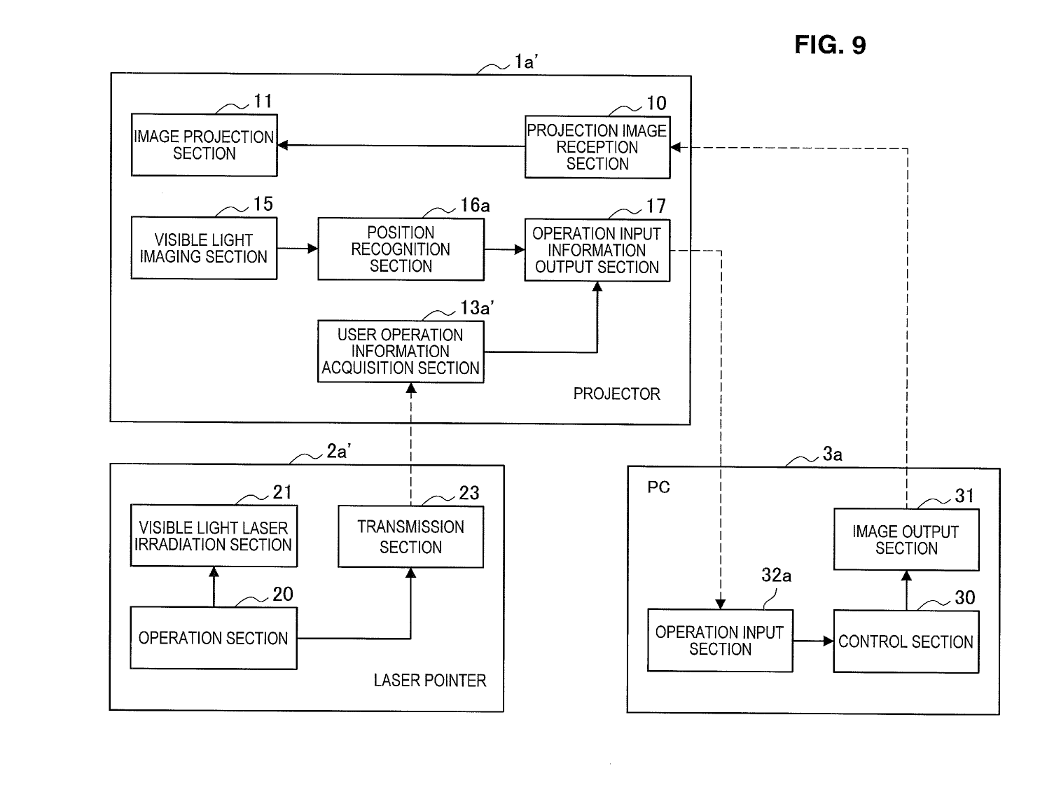

Heretofore, the operation system according to the first embodiment has been specifically described. While the user operation information acquisition section 13a of the projector 1a according the above described embodiment acquires user operation information (a fully-pressed operation of the operation button 20a or the like) detected by the laser pointer 2a based on the non-visible light marker, the acquisition method of the user operation information according to the present embodiment is not limited to this. For example, the projector 1a may receive user operation information from the laser pointer 2a wirelessly. Hereinafter, the case in which user operation information is wirelessly received will be described as a modified example of the first embodiment with reference to FIG. 8 to FIG. 9. The operation system according to the modified example includes a projector 1a′ (an information processing apparatus according to an embodiment of the present disclosure), a laser pointer 2a′, and a PC 3a. Since the internal configuration example of the PC 3a is similar to the same block described with reference to FIG. 5, a description of this will be omitted here.

FIG. 8 is a figure for describing the laser pointer 2a′ according to the modified example of the first embodiment. As shown on the left side of FIG. 8, the laser pointer 2a′ irradiates laser light V by visible light rays while the operation button 20a is half-pressed.

Also, as shown on the right side of FIG. 8, when the operation button 20a is fully-pressed (completely pressed), the laser pointer 2a′ transmits user operation information, which shows that a fully-pressed operation has been performed, to the projector 1a′ wirelessly, while continuing to irradiate the laser light V. In this way, the laser pointer 2a′ according to the present modified example is different to the examples shown in FIG. 3A and FIG. 3B, and wirelessly transmits user operation information to the projector 1a′, in accordance with a fully-pressed operation of the operation button 20a by a user.

To continue, an internal configuration example of each apparatus forming the operation system according to such a modified example will be specifically described with reference to FIG. 9.

FIG. 9 is a block diagram which shows an example of an internal configuration of the operation system according to the modified example of the first embodiment. As shown in FIG. 9, the projector 1a′ has a projection image reception section 10, an image projection section 11, a user operation information acquisition section 13a′, a visible light imaging section 15, a position recognition section 16a, and an operation input information output section 17. Since the projection image reception section 10, the image projection section 11, the visible light imaging section 15, the position recognition section 16a and the operation input information output section 17 are similar to the same blocks described with reference to FIG. 5, a description of them will be omitted here.

The user operation information acquisition section 13a′ has a function which receives user operation information from the laser pointer 2a′ wirelessly. While the system of wireless communication between the projector 1a′ and the laser pointer 2a′ is not particularly limited, transmission and reception of data is performed, for example, by Wi-Fi (registered trademark), Bluetooth (registered trademark) or the like.

Further, as shown in FIG. 9, the laser pointer 2a′ according to the modified example has an operation section 20, a visible light laser irradiation section 21, and a transmission section 23. Since the operation section 20 and the visible light laser irradiation section 21 are similar to the same blocks described with reference to FIG. 5, a description of them will be omitted here.

The transmission section 23 has a function which wirelessly communicates with a paired (connection set) projector 1a′. Specifically, in the case where a user operation is detected by the operation section 20, the transmission section 23 transmits information (user operation information), which shows the user operation (for example, a fully-pressed operation of the operation button 20a), to the projector 1a′.

By the above described configuration, first, a user operation (a fully-pressed operation of the operation button 20a or the like) performed for a projection image by a user by using the laser pointer 2a′ is transmitted to the projector 1a′ via wireless communication. To continue, the projector 1a′ transmits operation input information, which includes an irradiation position P by a visible light laser and the user operation received from the laser pointer 2a′, to the PC 3a. The PC 3a performs a process in accordance with the operation input information, and transmits an image for projection reflecting this information to the projector 1a′. Then, the projector 1a′ projects the image for projection, in which the process in accordance with the operation input information is reflected.

In this way, a user can intuitively perform an operation input for the projection image by using the laser pointer 2a′, without it being necessary for the laser pointer 2a′ to communicate with the PC 3a′.

### 2-2. The Second Embodiment

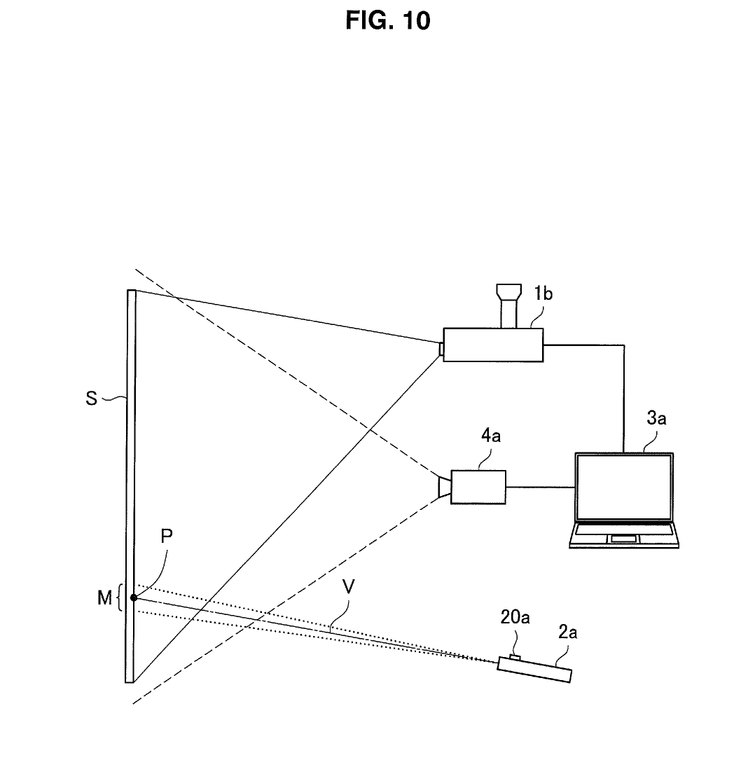

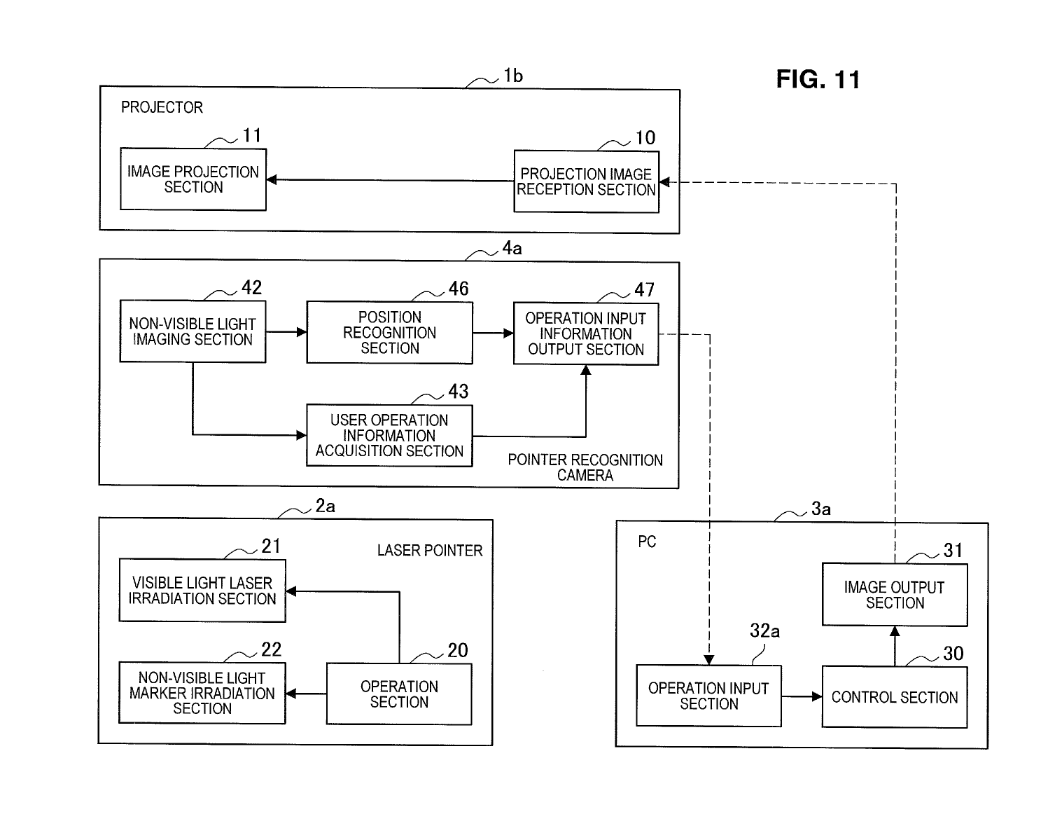

Next, a second embodiment according to the present disclosure will be specifically described with reference to FIG. 10 to FIG. 11. In the present embodiment, the non-visible light imaging section 12, the user operation information acquisition section 13a, the visible light imaging section 15, the position recognition section 16a and the operation input information output section 17 of the projector 1a according to the above described first embodiment are included in a apparatus (for the sake of convenience, called a pointer recognition camera) separate from the projector 1a. In this way, by newly introducing the pointer recognition camera (an information processing apparatus according to an embodiment of the present disclosure) according to the present embodiment into an existing projector system, an operation system can be built capable of an intuitive operation input by a laser pointer.

### 2-2-1. Overall Configuration

First, an overall configuration of the operation system according to the second embodiment will be described with reference to FIG. 10. FIG. 10 is a figure for describing an overall configuration of the operation system according to the second embodiment. As shown in FIG. 10, the operation system according to the present embodiment includes a projector 1b, a pointer recognition camera 4a, a laser pointer 2a, and a PC 3a. Since the functions of the laser pointer 2a and the PC 3a are similar to those of the first embodiment described with reference to FIG. 2, a description of them will be omitted here.

The projector 1b connects to the PC 3a by wires/wirelessly, and receives projection image data from the PC 3a. Then, the projector 1b projects an image on a screen S, based on the received image data.

The pointer recognition camera 4a images non-visible light for the projection image, recognizes a non-visible light marker M, and detects an indicated position (irradiation position P) by the laser pointer 2a and operation input information. Then, the pointer recognition camera 4a transmits the detected operation input information to the PC 3a.

The PC 3a executes a control in accordance with the operation input information received from the pointer recognition camera 4a, and transmits the projection image data, in which the operation input information is reflected, to the projector 1b.

In this way, according to the operation system according to the present embodiment, a user can perform an intuitive operation input, such as pressing the operation button 20a, in accordance with an irradiation position P of laser light V irradiated from the laser pointer 2a to an arbitrary position on a projection image.

### 2-2-2. Internal Configuration

To continue, an internal configuration of each apparatus included in the operation system according to the present embodiment will be specifically described with reference to FIG. 11. FIG. 11 is a block diagram which shows an example of an internal configuration of the operation system according to the second embodiment.

(Projector 1b)

As shown in FIG. 11, the projector 1b has a projection image reception section 10 and an image projection section 11. Similar to the first embodiment, the projection image reception section 10 receives projection image data from the PC 3a by wires/wirelessly, and outputs the received projection image data to the image projection section 11. The image projection section 11 performs projection of an image on the screen S, based on the image data output from the projection image reception section 10.

(Pointer Recognition Camera 4a)

As shown in FIG. 11, the pointer recognition camera 4a has a non-visible light imaging section 42, a user operation information acquisition section 43, a position recognition section 46, and an operation input information output section 47.

Similar to the non-visible light imaging section 12 according to the first embodiment, the non-visible light imaging section 42 has a function which images a non-visible light marker M irradiated by the laser pointer 2a on a projected image. The imaging range by the non-visible light imaging section 42 is adjusted to a range which includes the projection image projected on the screen S.

The position recognition section 46 recognizes a coordinate position of the non-visible light marker M, based on a non-visible light captured image captured by the non-visible light imaging section 42. Since the non-visible light marker M is irradiated at the same position or near an irradiation position P by laser light, the position recognition section 46 can recognize the coordinate position of the non-visible light marker M as the irradiation position P by laser light.

Similar to the user operation information acquisition section 13a according to the first embodiment, the user operation information acquisition section 43 functions as an acquisition section which acquires information of a user operation detected by the laser pointer 2a, based on a non-visible light captured image capturing the non-visible light marker M.

Similar to the operation input information output section 17 according to the first embodiment, the operation input information output section 47 has a function which detects operation input information for the projection image, based on the user operation information output from the user operation information acquisition section 43, and information which shows the irradiation position P output from the position recognition section 46. Further, the operation input information output section 47 has a function which transmits the detected operation input information to the PC 3a by wires/wirelessly.

(Laser Pointer 2a)

Since the internal configuration of the laser pointer 2a is similar to that of the first embodiment described with reference to FIG. 5, a description of this will be omitted here.

(PC 3a)

The internal configuration of the PC 3a is similar to that of the first embodiment described with reference to FIG. 5. In particular, the operation input section 32a according to the present embodiment has a function which receives operation input information from the pointer recognition camera 4a. The operation input section 32a outputs the operation input information received from the pointer recognition camera 4a to the control section 30. Then, the control section 30 executes a process in accordance with the operation input information, and transmits projection image data, in which the process is reflected, from the image output section 31 to the projector 1b.

As described above, by having a configuration which includes the pointer recognition camera 4a (an information processing apparatus according to an embodiment of the present disclosure) separate from the projector 1b, the operation system according to the second embodiment enables an intuitive user operation for a projection image using the laser pointer 2a.

### 2-3. The Third Embodiment

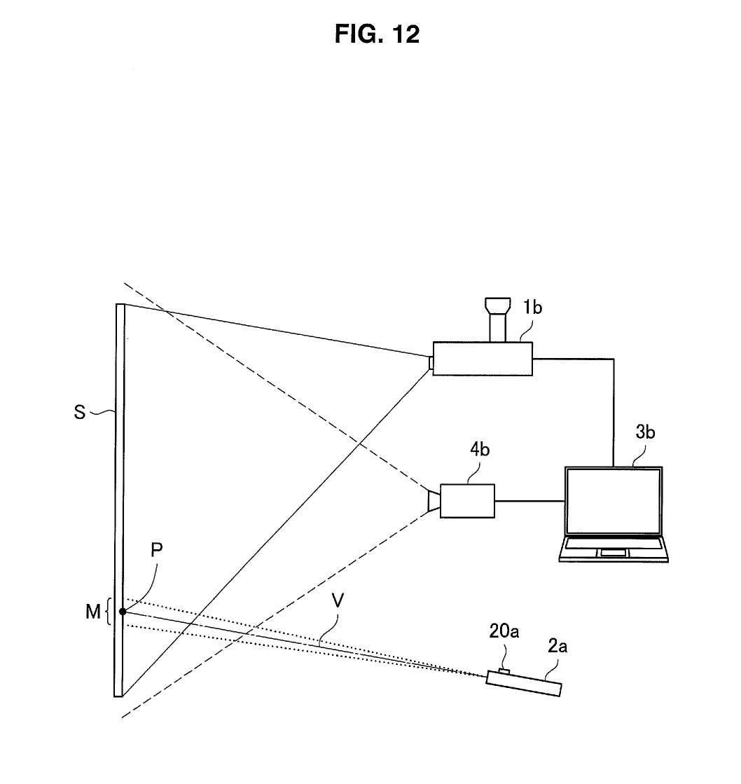

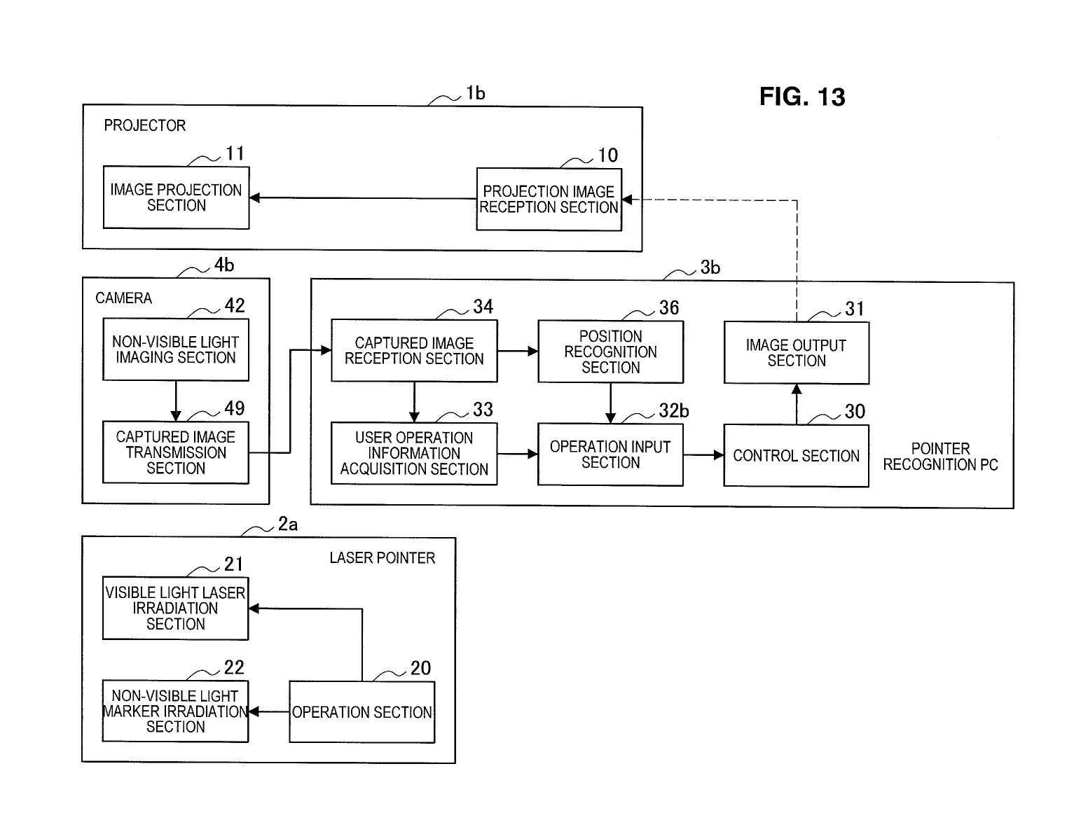

Next, a third embodiment according to the present disclosure will be specifically described with reference to FIG. 12 to FIG. 13. In the present embodiment, a pointer recognition engine, which includes the functions of the user operation information acquisition section 43, the position recognition section 46 and the operation input information output section 47 of the pointer recognition camera 4a according to the above described second embodiment, is built into the PC 3. In this way, by newly introducing a PC (hereinafter, called a pointer recognition PC), which has the pointer recognition engine according to the present embodiment built in, into an existing projector system having a projector and a camera, an operation system can be built capable of an intuitive operation input by a laser pointer. The incorporation of the pointer recognition engine may be by hardware, or may be by software. For example, it is possible to implement the pointer recognition PC by incorporating a pointer recognition application into a generic PC.

### 2-3-1. Overall Configuration

First, an overall configuration of the operation system according to the third embodiment will be described with reference to FIG. 12. FIG. 12 is a figure for describing an overall configuration of the operation system according to the third embodiment. As shown in FIG. 12, the operation system according to the present embodiment includes a projector 1b, a camera 4b, a laser pointer 2a, and a pointer recognition PC 3b (an information processing apparatus according to an embodiment of the present disclosure). Since the functions of the projector 1b and the laser pointer 2a are similar to those of the second embodiment disclosed with reference to FIG. 11, a description of these will be omitted here.

The camera 4b connects to the pointer recognition PC 3b by wires/wirelessly, and transmits a non-visible light captured image capturing non-visible light for a projection image to the PC 3b.

The pointer recognition PC 3b recognizes a non-visible light marker M based on the non-visible light captured image, and detects an indicated position (irradiation position P) by the laser pointer 2a and operation input information. Then, the PC 3a executes a control in accordance with the detected operation input information, and transmits projection image data, in which the operation input information is reflected, to the projector 1b.

In this way, according to the operation system according to the present embodiment, a user can perform an intuitive operation input, such as pressing the operation button 20a, in accordance with an irradiation position P of laser light V irradiated from the laser pointer 2a to an arbitrary position on a projection image.

### 2-3-2. Internal Configuration

To continue, an internal configuration of each apparatus included in the operation system according to the present embodiment will be specifically disclosed with reference to FIG. 13. FIG. 13 is a block diagram which shows an example of an internal configuration of the operation system according to the third embodiment. Note that, since the internal configuration of the projector 1b and the laser pointer 2a are similar to those of the second embodiment disclosed with reference to FIG. 11, a description of them will be omitted here.

(Camera 4b)

As shown in FIG. 13, the camera 4b has a non-visible light imaging section 42 and a captured image transmission section 49. Similar to the same block according to the second embodiment shown in FIG. 11, the non-visible light imaging section 42 has a function which captures a non-visible light marker M irradiated by the laser pointer 2a on the projected image. The captured image transmission section 49 transmits a non-visible light captured image captured by the non-visible light imaging section 42 to the pointer recognition PC 3b by wires/wirelessly.

(Pointer Recognition PC 3b)

As shown in FIG. 13, the pointer recognition PC 3b has a control section 30, an image output section 31, an operation input section 32b, a user operation information acquisition section 33, a captured image reception section 34, and a position recognition section 36.

The captured image reception section 34 receives a non-visible light captured image from the camera 4b by wires/wirelessly, and outputs the received non-visible light captured image to the position recognition section 36 and the user operation information acquisition section 33.

Similar to the position recognition section 46 according to the second embodiment shown in FIG. 11, the position recognition section 36 recognizes a coordinate position of a non-visible light marker M, based on a non-visible light captured image. Since the non-visible light marker M is irradiated at the same position or near an irradiation position P by laser light, the position recognition section 36 can recognize the coordinate position of the non-visible light marker M as the irradiation position P by laser light.

Similar to the user operation information acquisition section 43 according to the second embodiment shown in FIG. 11, the user operation information acquisition section 33 functions as an acquisition section which acquires information of a user operation detected by the laser pointer 2a, based on a non-visible light captured image capturing a non-visible light marker M.

The operation input section 32b has a function similar to that of the operation input information output section 47 according to the second embodiment shown in FIG. 11. Specifically, the operation input section 32b has a function which detects operation input information for a projection image, based on the user operation information detected from the user operation information acquisition section 33 and information which shows an irradiation position P detected from the position recognition section 36. Then, the operation input section 32b outputs the detected operation input information to the control section 30.

The control section 30 executes a process in accordance with the operation input information, and transmits projection image data, in which the process is reflected, from the image output section 31 to the projector 1b.

As described above, the operation system according to the third embodiment includes the PC 3b (an information processing apparatus according to an embodiment of the present disclosure), which has the pointer recognition engine built in, separate from the camera 4b, and is capable of performing an intuitive user operation for a projection image using the laser pointer 2a.

### 2-4. The Fourth Embodiment

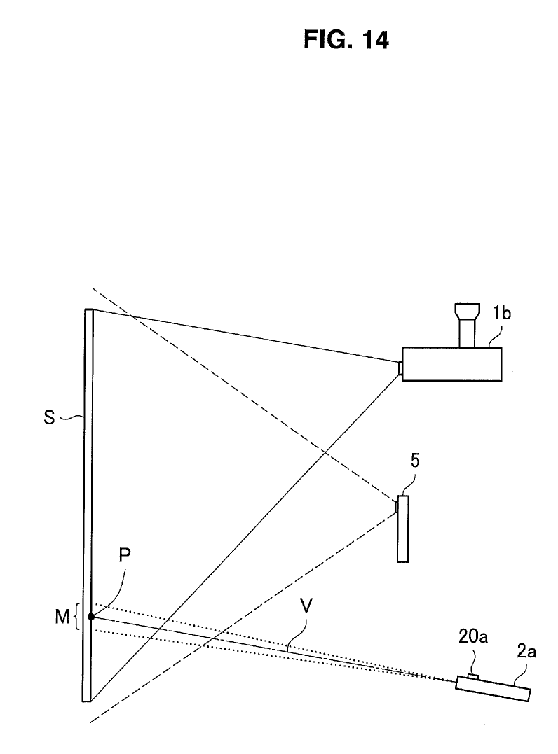

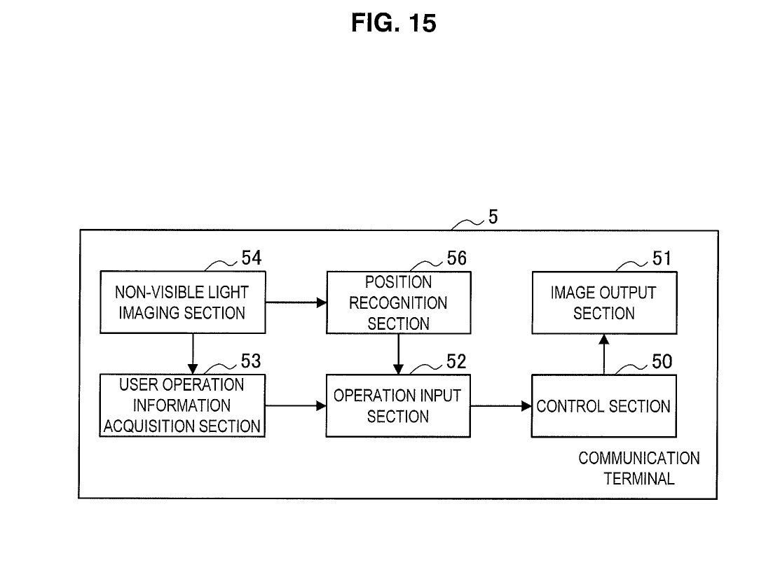

Next, a fourth embodiment according to the present disclosure will be specifically described with reference to FIG. 14 to FIG. 15. In the present embodiment, the camera 4b and the PC 3b, which has the pointer recognition engine built in, according to the above described third embodiment are implemented by an integrated apparatus. Specifically, for example, the camera 4b and the PC 3b are implemented by incorporating the pointer recognition engine into a mobile communication terminal (smart phone, tablet terminal or the like) with a built-in camera. In this way, by newly introducing a communication terminal, in which the pointer recognition engine according to the present embodiment is incorporated, into an existing projector system by a projector, an operation system can be built capable of performing an intuitive operation input by a laser pointer. Incorporation of the pointer recognition engine may be by hardware, or may be by software. For example, it is possible to implement a communication terminal for pointer recognition by incorporating an application for pointer recognition into a generic communication terminal

### 2-4-1. Overall Configuration

First, an overall configuration of the operation system according to the fourth embodiment will be described with reference to FIG. 14. FIG. 14 is a figure for describing an overall configuration of the operation system according to the fourth embodiment. As shown in FIG. 14, the operation system according to the present embodiment includes a projector 1b, a communication terminal 5 (an information processing apparatus according to an embodiment of the present disclosure), and a laser pointer 2a. Since the functions of the projector 1b and the laser pointer 2a are similar to those of the third embodiment shown in FIG. 12 and FIG. 13, a description of them will be omitted here.

The communication terminal 5 connects to the projector 1b by wires/wirelessly, and transmits projection image data. Further, the communication terminal 5 analyzes a non-visible light marker M irradiated from the laser pointer 2a, based on a non-visible light captured image capturing non-visible light from an image projected on a screen S, and acquires an irradiation position P and user operation information. Further, the communication terminal 5 detects operation input information based on the irradiation position P and the user operation information, and executes a control in accordance with the detected operation input information. Then, the communication terminal 5 transmits projection image data for projection, in which the operation input information is reflected, to the projector 1b.

In this way, according to the operation system according to the present embodiment, a user can perform an intuitive operation input, such as pressing the operation button 20a, in accordance with an irradiation position P of laser light V irradiated from the laser pointer 2a to an arbitrary position on a projection image.

### 2-4-2. Internal Configuration

To continue, an internal configuration of the communication terminal 5 included in the operation system according to the present embodiment will be specifically described with reference to FIG. 15. FIG. 15 is a block diagram which shows an example of an internal configuration of the communication terminal 5 according to the fourth embodiment.

The communication terminal 5 has a control section 50, an image output section 51, an operation input section 52, a user operation information acquisition section 53, a non-visible light imaging section 54, and a position recognition section 56.

The non-visible light imaging section 54 has a function which captures a non-visible light marker M irradiated by the laser pointer 2a on an image projected on the screen S.

Similar to the position recognition section 36 according to the third embodiment shown in FIG. 13, the position recognition section 56 recognizes a coordinate position of a non-visible light marker M, based on a non-visible light captured image. Since the non-visible light marker M is irradiated to the same position or near an irradiation position P by laser light, the position recognition section 56 can recognize the coordinate position of the non-visible light marker M as the irradiation position P by laser light.

Similar to the user operation information acquisition section 33 according to the third embodiment shown in FIG. 13, the user operation information acquisition section 53 functions as an acquisition section which acquires information of a user operation detected by the laser pointer 2a, based on a non-visible light captured image capturing a non-visible light marker M.

The operation input section 52 has a function similar to that of the operation input section 32b according to the third embodiment shown in FIG. 13. Specifically, the operation input section 52 has a function which detects operation input information for a projection image, based on the user operation information output from the user operation information acquisition section 53, and information which shows the irradiation position P output from the position recognition section 56. Then, the operation input section 52 outputs the detected operation input information to the control section 30.

The control section 30 executes a process in accordance with the operation input information, and transmits projection image data, in which the process is reflected, from the image output section 31 to the projector 1b.

As described above, the operation system according to the fourth embodiment includes the communication terminal 5, (an information processing apparatus according to an embodiment of the present disclosure), which has a camera is built in and the pointer recognition engine incorporated, and is capable of performing an intuitive user operation for a projection image using the laser pointer 2a.

### 2-5. The Fifth Embodiment

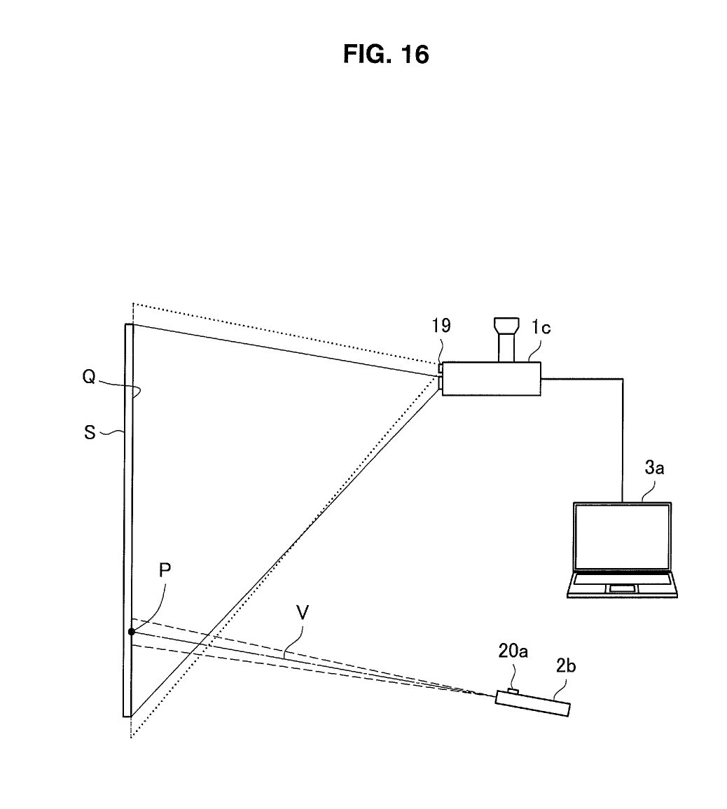

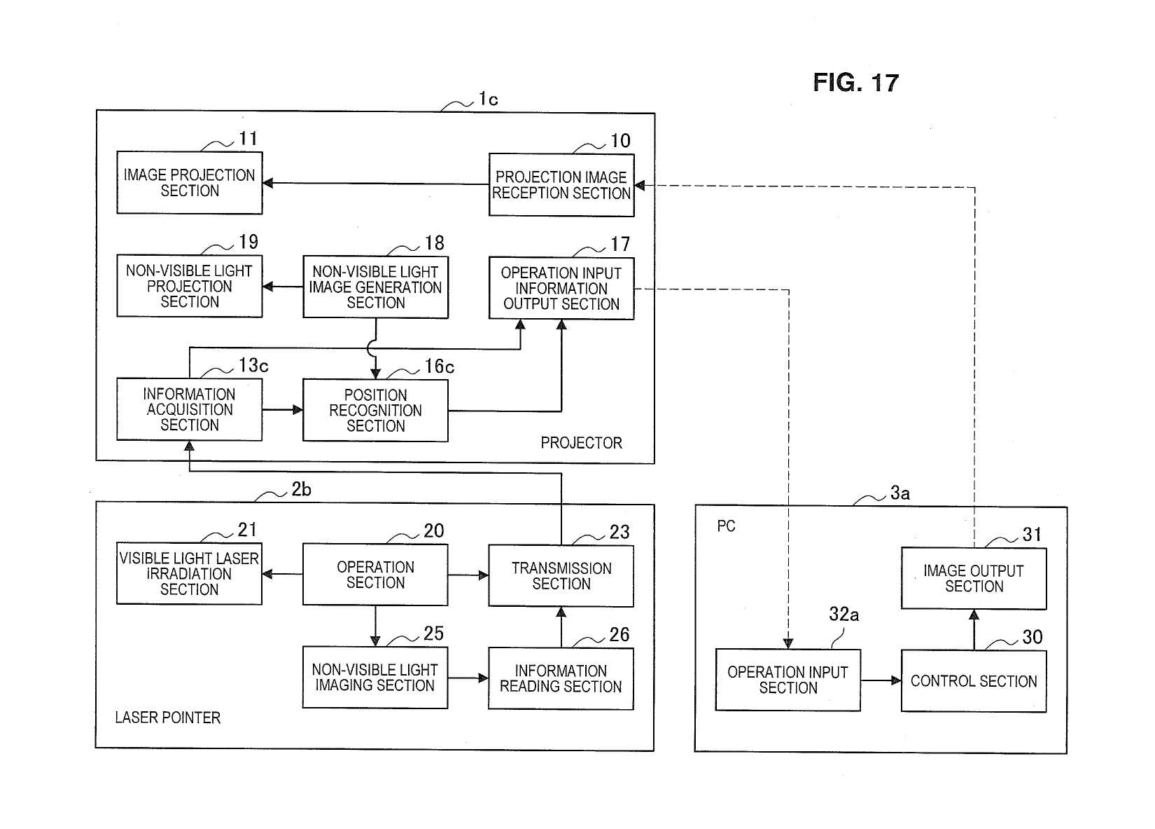

Next, a fifth embodiment of the present disclosure will be specifically described with reference to FIG. 16 to FIG. 17. In each of the above described embodiments, an image (projection image) projected on a screen S is captured, by a camera included in the projector 1a, a unit camera or a camera included in the communication terminal 5, and an irradiation position P is recognized based on a captured image. However, the recognition method of an irradiation position P by the operation system according to an embodiment of the present disclosure is not limited to those of each of the above described embodiments, and may be a method, for example, which includes a camera in the laser pointer 2, and performs recognition of a non-visible light image and an irradiation position P only in the case where the operation button 20a is pressed. In this way, by performing recognition of a non-visible light image and an irradiation position P only in the case where the operation button 20a is pressed, unnecessary power consumption can be eliminated.

### 2-5-1. Overall Configuration

First, an overall configuration of the operation system according to the fifth embodiment will be described with reference to FIG. 16. FIG. 16 is a figure for describing an overall configuration of the operation system according to the fifth embodiment. As shown in FIG. 16, the operation system according to the present embodiment includes a projector 1c (an information processing apparatus according to an embodiment of the present disclosure), a laser pointer 2b, and a PC 3a. Since the function of the PC 3a is similar to that of the above described first embodiment, a description of this will be omitted here.

The projector 1c connects to the PC 3a by wires/wirelessly, and receives projection image data from the PC 3a. Further, the projector 1c projects the projection image data on a screen S. In addition, the projector 1c according to the present embodiment projects a coordinate specification map (called a coordinate recognition image) Q of non-visible light such as infrared light superimposed on the screen S (image projection area). A projection area of the coordinate specification map Q of non-visible light may be in a range which includes the image projection area.

Further, when initialized, the projector 1c may project a non-visible light image, which has information embedded in order for the laser pointer 2b to perform a connection setting of wireless communication with the projector 1c, superimposed on the screen S (image projection area).

The laser pointer 2b performs irradiation of visible light rays (laser light V) and transmission control of user operation information, in accordance with a pressing state of the operation button 20a. Specifically, for example, the laser pointer 2b irradiates the laser light V in the case where the operation button 20a is half-pressed, and transmits information (user operation information) showing a fully-pressed operation to the projector 1c by wireless communication, while continuing irradiation of the laser light V, in the case where the operation button 20a is fully-pressed.

In addition, in the case where the operation button 20a is fully-pressed, the laser pointer 2b according to the present embodiment captures non-visible light for a range which includes the irradiation position P of the laser light V. In the case when initialized, the laser pointer 2b can read connection information from a non-visible light captured image, and can automatically perform a wireless connection setting with the projector 1c based on this connection information. Note that, the connection setting (pairing) of the laser pointer 2b and the projector 1c may be performed manually by a user.

Further, the laser pointer 2b recognizes a coordinate specification map Q′ included in the non-visible light captured image, and reads coordinate specification information or the like. Then, the laser pointer 2b transmits information which has been read (hereinafter, called read information), along with the user operation information, to the projector 1c by wireless communication.

The projector 1c, which has received the user operation information and the read information from the laser pointer 2b, can recognize the irradiation position P of the laser pointer 2b based on the read information. Further, the projector 1c detects the operation input information based on the irradiation position P and the user operation information, and transmits the detected operation input information to the PC 3a.

The PC 3a executes a control in accordance with the transmitted operation input information, and transmits projection image data, in which the operation input information is reflected, to the projector 1c.

In this way, according to the operation system according to the present embodiment, a coordinate specification map of non-visible light is projected from the projector 1c superimposed on a projection image, non-visible light is captured at the laser pointer 2b side, and an irradiation position P is recognized by the laser pointer 2a based on this non-visible light captured image.

### 2-1-2. Internal Configuration

To continue, an internal configuration of each apparatus included in the operation system according to the present embodiment will be specifically described with reference to FIG. 17. FIG. 17 is a block diagram which shows an example of an internal configuration of the operation system according to the fifth embodiment.

(Projector 1c)

The projector 1c has a projection image reception section 10, an image projection section 11, a non-visible light image generation section 18, a non-visible light projection section 19, an information acquisition section 13c, a position recognition section 16c, and an operation input information output section 17.

Since the projection image reception section 10 and the image projection section 11 are similar to the same blocks according to the first embodiment, a description of them will be omitted here.

The non-visible light image generation section 18 generates a coordinate specification map Q of non-visible light in which coordinate specification information used when recognizing an irradiation position P by the laser pointer 2b is embedded, and an image of non-visible light in which connection information is embedded.

The non-visible light projection section 19 projects the coordinate specification map Q of non-visible light and the image in which connection information is embedded generated by the non-visible light image generation section 18 superimposed on a projection image of the screen S. Note that, the projection by the non-visible light projection section 19 and the image projection section 11 may be projected via different filters by a same light source.

The information acquisition section 13c wirelessly communicates with the laser pointer 2b, and receives user operation information and read information from the laser pointer 2b.

The position recognition section 16c recognizes an irradiation position P (coordinate position) by the laser pointer 2b, based on the coordinate specification map Q created by the non-visible light image generation section 18, and the coordinate specification information which is included in the read information received by the information acquisition section 13c and read from the coordinate specification map Q′ capturing non-visible light. For example, the position recognition section 16c compares the coordinate specification map Q and the coordinate specification map Q′ shown by the coordinate specification information, and specifies a position of the coordinate specification map Q′ in the coordinate specification map Q. Then, the position recognition section 16c recognizes a central position of the coordinate specification map Q′ as the irradiation position P (coordinate position) by the laser pointer 2b.

The operation input information output section 17 has a function which detects operation input information for the projection image, based on the user operation information received by the information acquisition section 13c, and the irradiation position P recognized by the position recognition section 16c. Further, the operation input information output section 17 transmits the detected operation input information to the PC 3a by wires/wirelessly.

(Laser Pointer 2b)

As shown in FIG. 17, the laser pointer 2b has an operation section 20, a visible light laser irradiation section 21, a non-visible light imaging section 25, an information reading section 26, and a transmission section 23.

The visible light laser irradiation section 21 has a function which irradiates laser light V (visible light), in accordance with a user operation detected by the operation section 20. Specifically, for example, in the case where the operation button 20a is half-pressed, the visible light laser irradiation section 21 irradiates laser light V.

The non-visible light imaging section 25 has a function which captures non-visible light in a range which includes a position (irradiation position P) irradiated by the laser light V in accordance with a user operation detected by the operation section 20. For example, the non-visible light imaging section 25 performs non-visible light imaging only in the case where the operation button 20a is fully-pressed.

The information reading section 26 recognizes the coordinate specification map Q′, based on a non-visible light captured image, and reads coordinate specification information or the like.

The transmission section 23 transmits information (read information) read by the information reading section 26, and user operation information (for example, a fully-pressed operation) detected by the operation section 20, to the projector 1c by wireless communication.

In this way, for example, the laser pointer 2b according to the present embodiment irradiates the laser light V in the case where the operation button 20a is half-pressed (a first stage operation). Also, in the case where the operation button 20a is fully-pressed (a second stage operation), the laser pointer 2b performs non-visible light imaging while irradiating the laser light V, and wirelessly transmits information read from the non-visible light captured image and user operation information to the projector 1c. In this way, a user can intuitively perform an operation input for the projection image by using the laser pointer 2b.

(PC 3a)

The internal configuration of the PC 3a is similar to that of the first embodiment. That is, the operation input section 32a receives operation input information from the projector 1c, and the control section 30 executes a process in accordance with this operation input information. Further, the image output section 31 transmits projection image data, in which the process by the control section 30 is reflected, to the projector 1c.

As described above, in the operation system according to the fifth embodiment, a camera (the non-visible light imaging section 25) is included in the laser pointer 2b, and non-visible light imaging is performed in accordance with a user operation detected by the laser pointer 2b. Further, the projector 1c can receive coordinate specification information read from the coordinate specification map Q′ capturing non-visible light at the laser pointer 2b side, and can recognize an irradiation position P by the laser pointer 2b, based on this coordinate specification information.

### 2-6. The Sixth Embodiment

The configuration of each apparatus included in the operation system according to the above described fifth embodiment is one example, and each configuration of the operation system according to an embodiment of the present disclosure is not limited to the example shown in FIG. 17. For example, the non-visible light image generation section 18, the non-visible light projection section 19, the information acquisition section 13c, the position recognition section 16c and the operation input information output section 17 of the projector 1c according to the above described fifth embodiment may be included in an apparatus (for the sake of convenience, called a pointer recognition apparatus) separate from the projector 1c. In this way, by newly introducing the pointer recognition apparatus (an information processing apparatus according to an embodiment of the present disclosure) according to the present embodiment into an existing projector system, an operation system can be built capable of an intuitive operation input by a laser pointer.

### 2-6-1. Overall Configuration

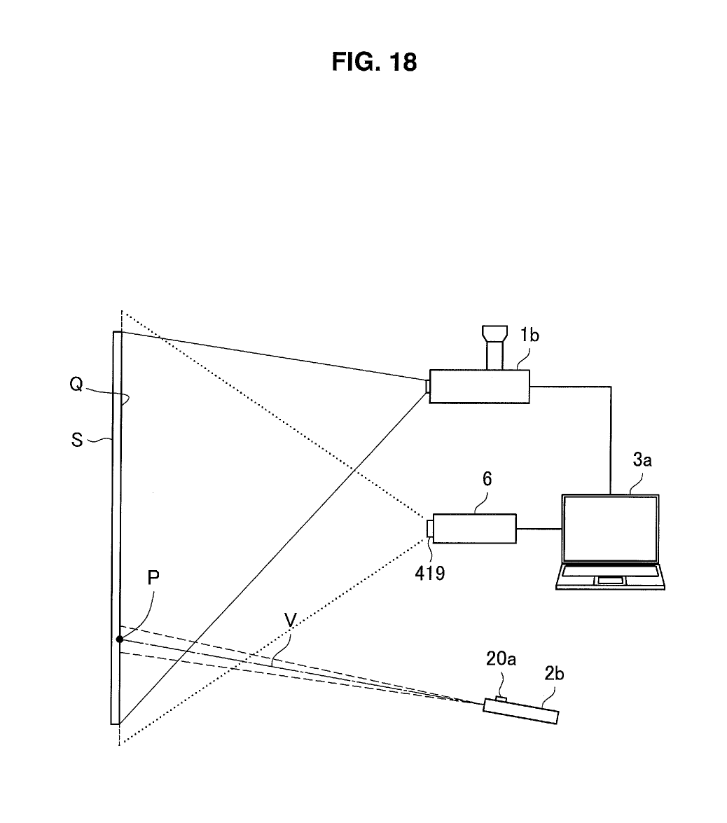

First, an overall configuration of the operation system according to the sixth embodiment will be described with reference to FIG. 18. FIG. 18 is a figure for describing an overall configuration of the operation system according to the sixth embodiment. As shown in FIG. 18, the operation system according the present embodiment includes a projector 1b, a pointer recognition apparatus 6, a laser pointer 2b, and a PC 3a. Since the PC 3a is similar to that of the above described first embodiment, the projector 1b is similar to that of the above described second embodiment, and the laser pointer 2b is similar to that of the above described fifth embodiment, a specific description of them will be omitted here.

The pointer recognition apparatus 6 projects a coordinate specification map Q of non-visible light such as infrared light superimposed on a screen S (image projection area). A projection area of the coordinate specification map Q of non-visible light may be in a range which includes the image projection area.

Similar to that of the fifth embodiment, the laser pointer 2b irradiates laser light V, in accordance with a pressing operation of the operation button 20a, captures non-visible light in a range which includes an irradiation position P on the screen S, and recognizes a coordinate specification map Q′ included in a non-visible light captured image. Then, the laser pointer 2b transmits detected user operation information, and information read from the coordinate specification map Q′, to the pointer recognition apparatus 6.

The pointer recognition apparatus 6 recognizes the irradiation position P of the laser pointer 2b, based on read information received from the laser pointer 2b. Further, the pointer recognition apparatus 6 detects operation input information based on the recognized irradiation position P and user operation information received from the laser pointer 2b, and transmits the detected operation input information to the PC 3a.

The PC 3a executes a control in accordance with the transmitted operation input information, and transmits projection image data, in which the operation input information is reflected, to the projector 1c.

In this way, according to the operation system according to the present embodiment, by newly introducing the pointer recognition apparatus 6 (an information processing apparatus according to an embodiment of the present disclosure) according to the present embodiment in an existing projector system, an operation system can be built capable of an intuitive operation input by a laser pointer.

### 2-6-2. Internal Configuration

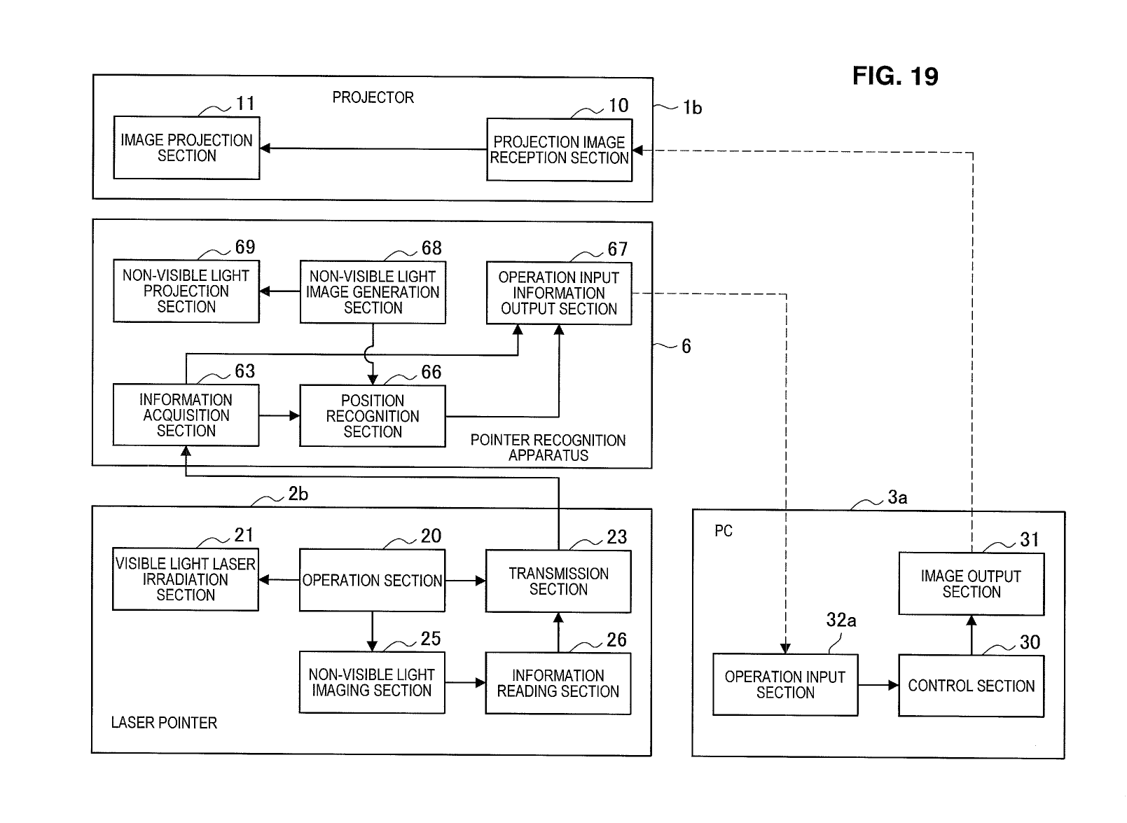

To continue, an internal configuration of each apparatus included in the operation system according to the present embodiment will be specifically described with reference to FIG. 19. FIG. 19 is a block diagram which shows an example of an internal configuration of the operation system according to the sixth embodiment. Note that, since the configuration of the PC 3a has a configuration similar to that of the above described first embodiment, the configuration of the projector 1b has a configuration similar to that of the above described second embodiment, and the configuration of the laser pointer 2b has a configuration similar to that of the above described fifth embodiment, a specific description of them will be omitted here.

(Pointer Recognition Apparatus 6)

As shown in FIG. 19, the pointer recognition apparatus 6 has a non-visible light image generation section 68, a non-visible light projection section 69, an information acquisition section 63, a position recognition section 66, and an operation input information output section 67.

Similar to the non-visible light image generation section 18 according to the fifth embodiment, the non-visible light image generation section 68 generates a coordinate specification map Q of non-visible light, and an image of non-visible light in which connection information is embedded.

Similar to the non-visible light projection section 19 according to the fifth embodiment, the non-visible light projection section 69 projects the coordinate specification map Q of non-visible light and the image in which connection information is embedded generated by the non-visible light image generation section 68 superimposed on a projection image of the screen S.

Similar to the information acquisition section 13c according to the fifth embodiment, the information acquisition section 63 wirelessly communicates with the laser pointer 2b, and receives user operation information and read information from the laser pointer 2b.

Similar to the position recognition section 16c according to the fifth embodiment, the position recognition section 66 recognizes an irradiation position P (coordinate position) by the laser pointer 2b, based on the coordinate specification map Q generated by the non-visible light image generation section 68, and the coordinate specification information read from the coordinate specification map Q′ capturing non-visible light.

Similar to the operation input information output section 17 according to the fifth embodiment, the operation input information output section 67 has a function which detects operation input information for a projection image, based on the user operation information received by the information acquisition section 63, and the irradiation position P recognized by the position recognition section 66. Further, the operation input information output section 67 transmits the detected operation input information to the PC 3a by wires/wirelessly.

As described above, by having a configuration which includes the pointer recognition apparatus 6 (an information processing apparatus according to an embodiment of the present disclosure) separate from the projector 1b, the operation system according to the sixth embodiment enables an intuitive user operation for a projection image by using the laser pointer 2b.

### 2-7. The Seventh Embodiment

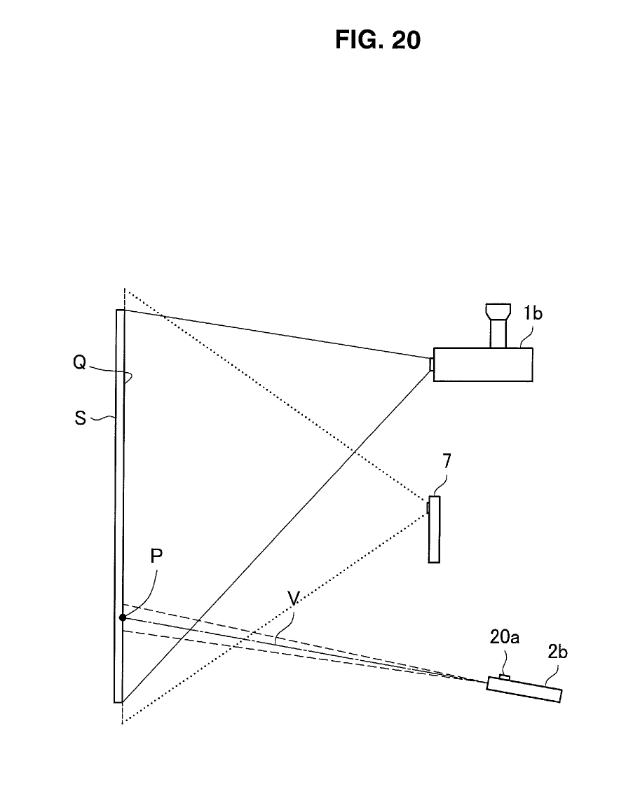

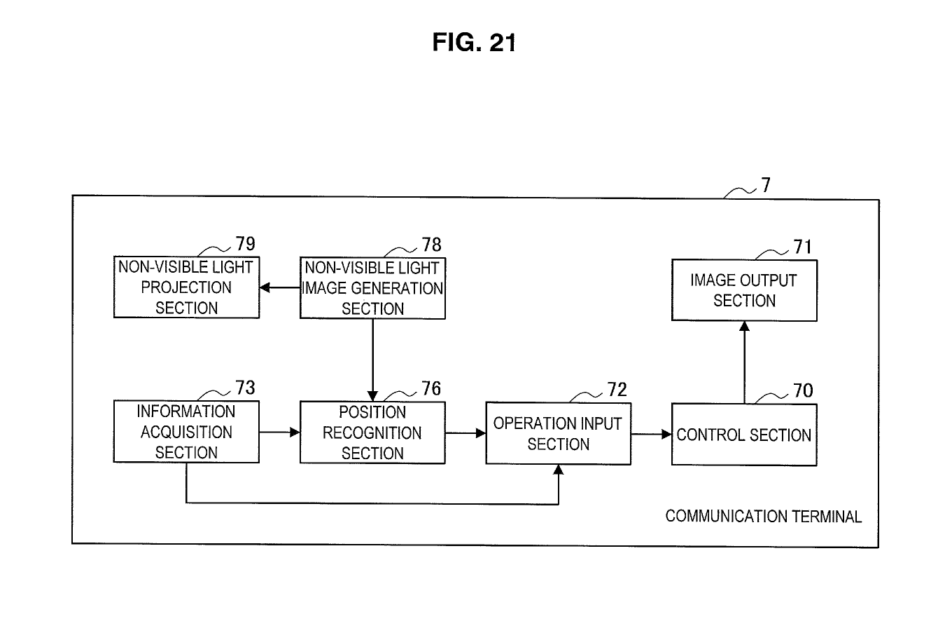

Next, a seventh embodiment according to the present disclosure will be specifically disclosed with reference to FIG. 20 to FIG. 21. In the present embodiment, the pointer recognition apparatus 6 and the PC 3a according to the above described sixth embodiment are implemented in an integrated apparatus. Specifically, for example, the pointer recognition apparatus 6 and the PC 3a are implemented by incorporating the pointer recognition engine into a mobile communication terminal (smartphone, tablet terminal or the like) with a built-in camera. In this way, by newly introducing a communication terminal, in which the pointer recognition engine according to the present embodiment is incorporated, into an existing projector system by a projector, an operation system can be built capable of performing an intuitive operation input by a laser pointer.

### 2-7-1. Overall Configuration

First, an overall configuration of the operation system according to the seventh embodiment will be described with reference to FIG. 20. FIG. 20 is a figure for describing an overall configuration of the operation system according to the seventh embodiment. As shown in FIG. 20, the operation system according to the present embodiment includes a projector 1b, a communication terminal 7 (an information processing apparatus according to an embodiment of the present disclosure), and a laser pointer 2b. Since the function of the projector 1b has been described in the above described second embodiment, and the function of the laser pointer 2b has been described in the above described fifth embodiment, a description of them will be omitted here.

The communication terminal 7 connects to the projector 1b by wires/wirelessly, and transmits projection image data. Further, the communication terminal 7 projects a coordinate specification map Q of non-visible light such as infrared light on an image projected on a screen S.

Further, the communication terminal 7 receives user operation information, and read information read from a non-visible light captured image captured by the laser pointer 2b, from the laser pointer 2b by wireless communication, and detects operation input information based on these. Then, the communication terminal 7 executes a control in accordance with the detected operation input information, and transmits projection image data, in which the operation input information is reflected, to the projector 1b.

In this way, according to the operation system according to the present embodiment, by introducing the communication terminal 7 (an information processing apparatus according to an embodiment of the present disclosure), in which the pointer recognition engine is incorporated, into an existing projector system, it is possible to perform an intuitive operation input by a laser pointer.

### 2-7-2. Internal Configuration

To continue, an internal configuration of the communication terminal 7 included in the operation system according to the present embodiment will be specifically described with reference to FIG. 21. FIG. 21 is a block diagram which shows an example of an internal configuration of the communication terminal 7 according to the seventh embodiment.

As shown in FIG. 21, the communication terminal 7 has a control section 70, an image output section 71, a non-visible light image generation section 78, a non-visible light projection section 79, an information acquisition section 73, a position recognition section 76, and an operation input section 72. The non-visible light image generation section 78, the non-visible light projection section 79, the information acquisition section 73 and the position recognition section 76 each have functions similar to the non-visible light image generation section 68, the non-visible light projection section 69, the information acquisition section 63 and the position recognition section 66 according to the sixth embodiment.

Further, similar to the operation input section 52 according to the sixth embodiment, the operation input section 72 has a function which detects operation input information for a projection image, based on user operation information output from the information acquisition section 73, and information which shows an irradiation position P detected from the position recognition section 76. Then, the operation input section 72 outputs the detected operation input information to the control section 70.

The control section 70 executes a process in accordance with the operation input information, and transmits projection image data, in which the process is reflected, from the image output section 71 to the projector 1b.

As described above, according to the sixth embodiment, by introducing the communication terminal 7 (an information processing apparatus according to an embodiment of the present disclosure), which has a camera built in and the pointer recognition engine incorporated, into an existing projector system, it becomes possible to perform an intuitive user operation for a projection image using the laser pointer 2b.

### 3. CONCLUSION

As described above, by using the laser pointer 2 in the operation system according to the present embodiment, an intuitive operation input can be performed for a projection image, while in a state in which laser light V is irradiated. The irradiation of laser light V is started by a first stage operation (for example, half-pressing of the operation button 20a), and a continuing second stage operation (for example, fully-pressing of the operation button 20a, pressing two times or the like) corresponds to an intuitive operation input. In this way, an intuitive operation input can be performed by the laser pointer 2, which corresponds to a click, drag, range selection, double click or the like of a mouse GUI, for a projected image (for example, a map, website or the like).

Specifically, in the above described first to fourth embodiments, user operation information (a fully-pressed operation of the operation button 20a or the like) detected by the laser pointer 2a is transmitted via a non-visible light marker M irradiated from the laser pointer 2a or via wireless communication. Further, in the above described first to fourth embodiments, the information processing apparatus according to an embodiment of the present disclosure is implemented by projectors 1a and 1a′, a pointer recognition camera 4a, a pointer recognition PC 3b, and a communication terminal 5. Such an information processing apparatus acquires user operation information detected by the laser pointer 2a, by analysis of a non-visible light image capturing the non-visible light marker M or by wireless communication with the laser pointer 2a. In addition, such an information processing apparatus recognizes an irradiation position P on a projection image indicated by laser light V of the laser pointer 2a, based on a visible light image/non-visible light image. Also, the information processing apparatus can detect operation input information, based on the recognized irradiation position P and the above described acquired user operation information.

Note that, the transmission of user operation information (a fully-pressed operation of the operation button 20a or the like) detected by the laser pointer 2a is not limited to transmission by the non-visible light marker M irradiated from the laser pointer 2a, and may be, for example, by a visible light marker.

Further, in the fifth to seventh embodiments, a coordinate specification map Q of non-visible light is projected superimposed on a projection image of a screen S, and non-visible light is captured by the laser pointer 2b. The laser pointer 2b transmits user operation information (a fully-pressed operation of the operation button 20a or the like) detected by the operation section 20, and read information read from a non-visible light captured image, to the information processing apparatus by wireless communication. In the above described fifth to seventh embodiments, the information processing apparatus according to an embodiment of the present disclosure is implemented by a projector 1c, a pointer recognition apparatus 6, and a communication terminal 7. Such an information processing apparatus recognizes an irradiation position P on a projection image indicated by laser light V of the laser pointer 2a, based on the read information received from the laser pointer 2b. Also, the information processing apparatus can detect operation input information, based on the recognized irradiation position P and the above described received user operation information.

It should be understood by those skilled in the art that various modifications, combinations, sub-combinations and alterations may occur depending on design requirements and other factors insofar as they are within the scope of the appended claims or the equivalents thereof.

For example, a computer program for causing hardware, such as a CPU, ROM and RAM built into the projectors 1a, 1a′ and 1c, the pointer recognition camera 4a, the pointer recognition apparatus 6, the pointer recognition PC 3b or the communication terminals 5 and 7, to exhibit functions of the above described projectors 1a, 1a′ and 1c, pointer recognition camera 4a, pointer recognition apparatus 6, pointer recognition PC 3b or communication terminals 5 and 7 can be created. Further, a computer-readable storage medium, on which this computer program is recorded, can also be provided.

Further, it is possible for the operation system according to an embodiment of the present disclosure to perform an intuitive operation input by a plurality of projectors 1. In this way, it becomes possible to perform collaboration by a plurality of people, or perform UI operations by a plurality of laser pointer 2 used in both hands.

For example, identification of each irradiation position P by the plurality of laser pointers 2 may be identified based on a user ID embedded in a one-dimensional bar code, a two-dimensional bar code or the like of non-visible light irradiated together with laser light V. Or, identification of each irradiation position P may be identified based on the color or shape of laser light V (visible light). A user can select the color or shape of laser light V by a switch included in the laser pointer 2a, on a display screen of a touch panel, or on a projection image.

Further, by performing audio output together with irradiating a non-visible light marker M in accordance with a second stage user operation, the laser pointer 2a according to the above described first to fourth embodiments can provide a user with feedback of an intuitive operation input.

Additionally, the present technology may also be configured as below:

(1) An information processing apparatus including:

a recognition section which recognizes an irradiation position of laser light by a laser pointer on a projection image;

an acquisition section which acquires information of a user operation detected by an operation section provided in the laser pointer; and

a detection section which detects operation input information for the projection image based on the irradiation position recognized by the recognition section and the user operation acquired by the acquisition section.

(2) The information processing apparatus according to (1),

wherein the recognition section recognizes the irradiation position based on a captured image capturing a projection surface.

(3) The information processing apparatus according to (1) or (2),

wherein the laser pointer irradiates a non-visible light marker corresponding to the user operation detected by the operation section, and

wherein the acquisition section acquires the information of the user operation based on a captured image capturing the non-visible light marker irradiated by the laser pointer.

(4) The information processing apparatus according to (3),

wherein the non-visible light marker is a point, a figure, a one-dimensional/two-dimensional bar code, or a moving image.

(5) The information processing apparatus according to (3) or (4),

wherein the recognition section recognizes position coordinates of the non-visible light marker as the irradiation position by the laser pointer based on the captured image capturing the non-visible light marker.

(6) The information processing apparatus according to (1) or (2),

wherein the acquisition section receives and acquires, from the laser pointer, the information of the user operation detected by the laser pointer.

(7) The information processing apparatus according to (1) or (2),

wherein the laser pointer irradiates a visible light marker corresponding to the user operation detected by the operation section, and

wherein the acquisition section acquires information of the user operation based on a captured image capturing the visible light marker irradiated by the laser pointer.

(8) The information processing apparatus according to (7),

wherein the laser pointer causes at least one of a shape and a color of the visible light maker to change in accordance with the user operation.

(9) The information processing apparatus according to any one of (1) to (8),

wherein the recognition section recognizes the irradiation position of laser light by the laser pointer on the projection image based on a captured image capturing a whole of the projection image.

(10) The information processing apparatus according to any one of (1) to (8),

wherein the recognition section recognizes the irradiation position of laser light by the laser pointer on the projection image based on a captured image capturing a coordinate recognition image of non-visible light superimposed and projected on the projection image.

(11) The information processing apparatus according to (10),

wherein the captured image capturing the coordinate recognition image of non-visible light is a captured image capturing an irradiation position surrounding of laser light by the laser pointer on the projection image.

(12) The information processing apparatus according to any one of (1) to (10),

wherein the recognition section recognizes the irradiation position of laser light by a plurality of laser pointers on the projection image,

wherein the plurality of laser pointers irradiate non-visible light or visible light markers which show identification information of the plurality of laser pointers, and

wherein the acquisition section acquires identification information for identifying each of the laser pointers based on captured images capturing the non-visible light or visible light markers irradiated by each of the plurality of laser pointers.

(13) An operation input detection method including:

recognizing an irradiation position of laser light by a laser pointer on a projection image;

acquiring information of a user operation detected by an operation section provided in the laser pointer; and

detecting operation input information for the projection image based on the recognized irradiation position and the acquired user operation.

(14) A program for causing a computer to function as:

a recognition section which recognizes an irradiation position of laser light by a laser pointer on a projection image;

an acquisition section which acquires information of a user operation detected by an operation section provided in the laser pointer; and

a detection section which detects operation input information for the projection image based on the irradiation position recognized by the recognition section and the user operation acquired by the acquisition section.

(15) A non-transitory computer-readable storage medium having a program stored therein, the program causing a computer to function as:

a recognition section which recognizes an irradiation position of laser light by a laser pointer on a projection image;

an acquisition section which acquires information of a user operation detected by an operation section provided in the laser pointer; and

a detection section which detects operation input information for the projection image based on the irradiation position recognized by the recognition section and the user operation acquired by the acquisition section.

What is claimed is:

1. An information processing apparatus comprising:
a recognition section which recognizes an irradiation position of laser light by a laser pointer on a projection image;
an acquisition section which acquires information of a user operation detected by an operation section provided in the laser pointer; and
a detection section which detects operation input information for the projection image based on the irradiation position recognized by the recognition section and the user operation acquired by the acquisition section.

2. The information processing apparatus according to claim 1,
wherein the recognition section recognizes the irradiation position based on a captured image capturing a projection surface.

3. The information processing apparatus according to claim 1,
wherein the laser pointer irradiates a non-visible light marker corresponding to the user operation detected by the operation section, and
wherein the acquisition section acquires the information of the user operation based on a captured image capturing the non-visible light marker irradiated by the laser pointer.

4. The information processing apparatus according to claim 3,
wherein the non-visible light marker is a point, a figure, a one-dimensional/two-dimensional bar code, or a moving image.

5. The information processing apparatus according to claim 3,
wherein the recognition section recognizes position coordinates of the non-visible light marker as the irradiation position by the laser pointer based on the captured image capturing the non-visible light marker.

6. The information processing apparatus according to claim 1,
wherein the acquisition section receives and acquires, from the laser pointer, the information of the user operation detected by the laser pointer.

7. The information processing apparatus according to claim 1,
wherein the laser pointer irradiates a visible light marker corresponding to the user operation detected by the operation section, and
wherein the acquisition section acquires information of the user operation based on a captured image capturing the visible light marker irradiated by the laser pointer.

8. The information processing apparatus according to claim 7,
wherein the laser pointer causes at least one of a shape and a color of the visible light maker to change in accordance with the user operation.

9. The information processing apparatus according to claim 1,
wherein the recognition section recognizes the irradiation position of laser light by the laser pointer on the projection image based on a captured image capturing a whole of the projection image.

10. The information processing apparatus according to claim 1,
wherein the recognition section recognizes the irradiation position of laser light by the laser pointer on the projection image based on a captured image capturing a coordinate recognition image of non-visible light superimposed and projected on the projection image.

11. The information processing apparatus according to claim 10,
wherein the captured image capturing the coordinate recognition image of non-visible light is a captured image capturing an irradiation position surrounding of laser light by the laser pointer on the projection image.

12. The information processing apparatus according to claim 1,
wherein the recognition section recognizes the irradiation position of laser light by a plurality of laser pointers on the projection image,
wherein the plurality of laser pointers irradiate non-visible light or visible light markers which show identification information of the plurality of laser pointers, and
wherein the acquisition section acquires identification information for identifying each of the laser pointers based on captured images capturing the non-visible light or visible light markers irradiated by each of the plurality of laser pointers.

13. An operation input detection method comprising:
recognizing an irradiation position of laser light by a laser pointer on a projection image;
acquiring information of a user operation detected by an operation section provided in the laser pointer; and
detecting operation input information for the projection image based on the recognized irradiation position and the acquired user operation.

14. A program for causing a computer to function as:
a recognition section which recognizes an irradiation position of laser light by a laser pointer on a projection image;
an acquisition section which acquires information of a user operation detected by an operation section provided in the laser pointer; and
a detection section which detects operation input information for the projection image based on the irradiation position recognized by the recognition section and the user operation acquired by the acquisition section.

15. A non-transitory computer-readable storage medium having a program stored therein, the program causing a computer to function as:
a recognition section which recognizes an irradiation position of laser light by a laser pointer on a projection image;
an acquisition section which acquires information of a user operation detected by an operation section provided in the laser pointer; and
a detection section which detects operation input information for the projection image based on the irradiation position recognized by the recognition section and the user operation acquired by the acquisition section.
